(19) United States
(12) Patent Application Publication
(10) Pub. No.: US 2013/0065037 A1
(43) Pub. Date: Mar. 14, 2013

(54) CELLULOSE ESTER FILM, LAYERED PRODUCT, POLARIZING PLATE AND LIQUID CRYSTAL DISPLAY DEVICE

(71) Applicants: Hidenori HAYASHI, Kanagawa (JP); Hajime NAKAYAMA, Kanagawa (JP)

(72) Inventors: Hidenori HAYASHI, Kanagawa (JP); Hajime NAKAYAMA, Kanagawa (JP)

(73) Assignee: FUJIFILM CORPORATION, Tokyo (JP)

(21) Appl. No.: 13/612,156

(22) Filed: Sep. 12, 2012

(30) Foreign Application Priority Data
Sep. 13, 2011 (JP) 2011-199679
Jan. 11, 2012 (JP) 2012-003480

(51) Int. Cl. C08B 3/00; G02B 5/30; B32B 37/14; B32B 23/20

(52) U.S. Cl. 428/220; 359/489.01; 359/486.02; 156/246; 536/58

(57) ABSTRACT

A cellulose ester film has: a ratio of a sound velocity in a width direction to a sound velocity in a longitudinal direction of from 0.9 to 1.1; a moist heat dimensional change rate in the width direction of from −0.2% to 0.2%, the moist heat dimensional change being one after the cellulose ester film is left standing at 60° C. and 90% RH for 24 hours; and a humidity dimensional change rate in the width direction of 0.38% or less.

This application claims the benefit of Japanese Patent Application Nos. 2011-199679 and 2012-003480, filed on Sep. 13, 2011 and Jan. 11, 2012, respectively, the entire contents of which are hereby incorporated by reference.

### BACKGROUND OF THE INVENTION

1. Field of the Invention

The present invention relates to a cellulose ester film, a layered product, a polarizing plate and a liquid crystal display device. More specifically, the present invention relates to a 2D/3D switchable image display panel and an image display system, which may display stereoscopic images (3D images) and 2-dimensional images (2D images), and a pattern retardation film used in the image display panel.

2. Background Art

In the 3D stereoscopic image display field in which a projected image is stereoscopically viewed as if the image is emerging so that a powerful image may be enjoyed, as 3D movies have been rapidly adopted in general recently, the 3D stereoscopic image display on a flat panel display, which is a closer scene to a person, is beginning to draw great attention. Various modes in which images are stereoscopically viewed by naked eyes, or dedicated glasses for watching stereoscopic images are used have been known in the stereoscopic display (3D display). However, unlike the case of sitting in a cinema to appreciate a 3D movie, the mode in which dedicated glasses are used draws attention from the viewpoint that images may be seen in movement of daily life.

In the meantime, the contents of 3D images for flat panel displays have not been sufficient yet as of now. For this reason, there is a need for an image display mode in which a conversion between 2D display (two dimensional display) and 3D display can be easily implemented, and both of 2D images and 3D stereoscopic images can also be displayed with high quality. As a mode meeting these needs, two modes such as a glasses shutter mode (active glasses mode) and a polarizing glasses mode (passive glasses mode) draw particular attention. Further, in the flat panel display field in which a high definition has recently progressed, only the two modes are considered to provide a high-quality 3D stereoscopic image while maintaining a high definition on a flat panel display in the related art. Among them, an improvement in the polarizing glasses mode is further required from the viewpoint that it can be widely disseminated at a relatively low cost.

In the polarizing glasses mode, an image for the left eye and an image for the right eye are displayed on a display, image light for the left eye and image light for the right eye, which are emitted from the display, are separated into two different polarization states (for example, right circularly polarized light and left circularly polarized light), respectively, and the display is observed through polarized glasses constituted with a right circularly polarized light transmission polarizing plate and a left circularly polarized light transmission polarizing plate, thereby obtaining a stereoscopic effect (see U.S. Pat. No. 5,327,285). In addition, as a method for displaying an image for the left eye and an image for the right eye on a display in the polarizing glasses mode, a screen division mode for displaying half of an original image on each of the half of the display, has been adopted for the image for the left eye and the image for the right eye. As the screen division mode, a line-by-line mode has been widely adopted, and this is a mode displaying, on every odd number line and even number line of scanning lines (hereinafter, also referred to as lines) of the display, respectively, a half of an image for the left eye with the number of pixels reduced to half of the original image for the left eye which corresponds to alternate lines of the original image for the left eye and a half of an image for the right eye with the number of pixels reduced to half of the original image for the right eye which corresponds to alternate lines of the original image for the right eye. Furthermore, as a method for making image light for the left eye and image light for the right eye, which are emitted from the display, into two different polarization states, respectively, a method for attaching a pattern retardation film in which different retardations are patterned in a repeating belt-like shape and disposed in response to a line width on the display has been widely adopted.

Recently, for a pattern retardation film in which different retardations are patterned in a repeating belt-like shape and disposed in response to a line width of the image display device, improvement and reduction in manufacturing costs have been further required for dissemination of 3D image display devices.

Herein, as a manufacturing method of the pattern retardation film, various methods are known (see U.S. Pat. No. 5,327,285, JP-A-2001-59949, JP-A-10-161108, JP-A-10-160933, and JP-A-10-153707).

In 3D display device using pattern film fabricated on polymer film as described in U.S. Pat. No. 5,327,285, JP-A-2001-59949, JP-A-10-161108, JP-A-10-160933, and JP-A-10-153707, it has been confirmed that in a 3D display device, a crosstalk has been viewed, which is generated by a misalignment occurring with a lapse of time to a patterning interval and pixels after a panel was turned ON. As for a factor of the phenomenon, WO 2011/102492 discloses a suppression of the change in dimension by suppressing expansion of a polymer film.

The description in WO 2011/102492 explains that a dimensional change in a specific direction may be suppressed by stretching cellulose ester film in one direction and reducing a coefficient of thermal expansion and a humidity expansion coefficient in one direction.

### SUMMARY OF THE INVENTION

Although certain result may be obtained by a technology as described in WO 2011/102492, recently, more strict quality is required to 3D-TV, and even under the condition of high temperature and high humidity, it is required not to reduce display quality. Therefore, manufacturers are pressed by the necessity of taking consideration into environment change other than temperature.

In consideration of the above situation, an object of the present invention is to provide a cellulose ester film which may be used as a support of a retardation film and has a reduced influence due to environmental changes by suppressing a change in dimension occurring under a certain environment. Another object of the present invention is to provide a layered product which may be used as a retardation film, in which optically anisotropic layer is placed on the cellulose ester film. Further, still another object of the present invention is to provide a polarizing plate and a liquid crystal display device utilizing the cellulose ester film or the layered product.

As described above, WO 2011/102492 suggests a technique for suppressing dimensional change in a certain direction by stretching cellulose ester film. Accordingly, it has been thought so far that dimensional change in a specific direction (for example, in a direction perpendicular to the orientating direction) may be suppressed by orienting a polymer through by a stretching treatment.

However, from the inventors' review, it is confirmed that, in addition to a reversible dimensional change caused by a moisture absorption, an irreversible dimensional change is occurred under a high temperature and high humidity environment, resulting in deterioration of display quality. Accordingly, it is understood that there are two kinds of dimensional changes, that is, a reversible dimensional change and an irreversible dimensional change. Hereinafter, the former is called as “humidity dimensional change”, and the latter is called as “moist heat dimensional change”.

A stretching treatment reduces the humidity dimensional change of the film, but an excessive stretching treatment further reduces the humidity dimensional change, and deteriorates the moist heat dimensional change, thereby causing a deterioration of entire dimensional change.

The inventors found that the quality requirements may be met through the reduction in moist heat dimensional change as well as the reduction in humidity dimensional change rate by performing a stretching treatment under a specific condition to set a sound velocity ratio of film within a specified range, as a method for suppressing both of the humidity dimensional change and the moist heat dimensional change.

First of all, the humidity dimensional change occurs by introducing moisture into a film. It has been considered that this is because a water molecule widens the space of a polymer chain compulsorily when the water molecule enters into the gap of the polymer (cellulose ester). The humidity dimensional change is a reversible dimensional change. When humidity is returned, the water molecule is extracted, and thus, dimension is returned to the original state.

In contrast, it has been considered that the moist heat dimensional change occurs by a residual stress inside the film generated by the stretching treatment. Under a normal temperature and a normal humidity, the deformation of a film does not occur by the residual stress, but the film may be deformed by the relief of the residual stress, because the film may be soften under a high temperature and a high humidity conditions. The moist heat dimensional change is an irreversible dimensional change caused by the relief of the residual stress. Even if the temperature and the humidity are returned to an original state, the dimension will not be returned to the original state.

Accordingly, the humidity dimensional change and the moist heat dimensional change are caused by different factors, and thus, both of the humidity dimensional change and the moist heat dimensional change can be suppressed simultaneously if each of the humidity dimensional change and the moist heat dimensional change can be controlled independently.

The present inventors have reviewed, and found that, on one hand, the reversible dimensional change may be suppressed by reducing the region for water molecule to enter by orienting polymer molecular chain of cellulose ester with a stretching treatment, and on the other hand, the irreversible dimensional change may be suppressed by reducing an inner residual stress occurred by stretching treatment under a certain stretching condition.

That is, the present inventors found that the dimensional change in a specific direction may be suppressed by stretching a cellulose ester film in one direction under certain conditions, and stabilizing the state of cellulose molecular chain in a specific direction.

Namely, the means for achieving the above mentioned objects are as follows.

(1) A cellulose ester film having: a ratio of a sound velocity in a width direction to a sound velocity in a longitudinal direction of from 0.9 to 1.1; a moist heat dimensional change rate in the width direction of from −0.2% to 0.2%, the moist heat dimensional change being one after the cellulose ester film is left standing at 60° C. and 90% RH for 24 hours; and a humidity dimensional change rate in the width direction of 0.38% or less.
(2) The cellulose ester film of (1), wherein a variation of the humidity dimensional change rate in the width direction is 10% or less.
(3) The cellulose ester film of (1) or (2), which has an in-plane retardation Re of from 0 nm to 5 nm and a thickness-direction retardation Rth of from 0 nm to 50 nm.
(4) The cellulose ester film of any one of (1) to (3), which has a width of from 1.8 m or more.
(5) The cellulose ester film of any one of (1) to (4), which includes a cellulose acylate having a total degree of acyl substitution of from 2.7 to 3.0.
(6) The cellulose ester film of any one of (1) to (5), which includes a cellulose ester and an additive in an amount of 10% by mass or more based on the cellulose ester.
(7) A layered product comprising: a cellulose ester of any one of (1) to (6); and an optically anisotropic layer.
(8) The layered product of (7), wherein the optically anisotropic layer includes a plurality of regions having refractive indices and arranged in a pattern in the longitudinal direction.
(9) The layered product of (8), wherein the optically anisotropic layer includes a first retardation region and a second retardation region that are arranged alternately in the width direction.
(10) A polarizing plate comprising: a cellulose ester film of any one of (1) to (6) or a layered product of any one of (7) to (9) as a protective film.
(11) A liquid crystal display device comprising a polarizing plate of (10), wherein the protective film of the cellulose ester film or the layered product is disposed closest to a viewer side.
(12) A method for preparing an optical film comprising;

forming a web on a support with a solution in which a cellulose ester is dissolved in an organic solvent, and peeling the web from the support;

stretching the web from 10% to 40% in a width direction to form a film; and

stacking an optically anisotropic layer on the film, the optically anisotropic layer having a plurality of retardation regions disposed in the width direction.

(13) The method of (12), wherein the optically anisotropic layer is formed by coating.

### DETAILED DESCRIPTION OF THE INVENTION

According to the present invention, it is possible to provide a cellulose ester film with small dimensional change caused by environment of a support of a retardation film. Further, according to the present invention, it is possible to provide a layered product including optically anisotropic layer on the cellulose ester film, which can be used as an optical retardation film, and also a polarizing plate and a liquid crystal display device using the cellulose ester or the layered product. In particular, in a 3D switchable image display panel, when a pattern retardation film is applied, which includes an optically anisotropic layer having a first retardation region and a second retardation region formed on a polymer film in which birefringence are mutually different from each other and in which the first retardation region and the second retardation region are alternately patterned for every one line, the occurrence of contraction in a direction perpendicular to the pattern produces a misalignment between the retardation regions and pixels of the panel, which is responsible for the crosstalk. However, it is possible to effectively prevent the phenomenon in the present invention.

Hereinafter, embodiments of the present invention will be described in detail. The description of constituent elements described hereinafter may be made based on a representative embodiment of the present invention, but the present invention is not limited to such an embodiment. Further, in the present specification, “to” is used to mean that numerical values described before and after the term are included as a lower limit and an upper limit.

In the present specification, “parallel” and “perpendicular” mean a range within an exact angle less than ±10°. For the range, an error with the exact angle is preferably less than ±5° and more preferably less than ±2°. In addition, “substantially vertical” means a range within an angle of the exact vertical angle less than ±20°. For the range, an error with the exact angle is preferably less than ±15° and more preferably less than ±10°. Furthermore, “slow axis” means the direction in which the refractive index becomes the maximum. Further, the wavelength at which the refractive index is measured is a value in the visible region with λ=550 nm unless otherwise particularly described.

In the present specification, “polarizing plate” is used as a meaning including both a long polarizing plate and a polarizing plate cut (in the present invention, “cut” includes “punched”, “cut out” and the like) to a size which enables the polarizing plate to be inserted into a liquid crystal display device, unless otherwise particularly specified. In addition, in the present specification, the “polarization film” and “polarizing plate” are used as different meanings, but the “polarizing plate” means a layered product having a transparent protective film at least on one side of a “polarization film” to protect the polarization film.

In the present description, Re (λ) and Rth (λ) represent an in-plane retardation and a retardation in a thickness-direction, respectively at a wavelength of λ. Re (λ) is measured by irradiating with an incident light with a wavelength of λ nm in the normal direction of a film using KOBRA 21ADH or WR (manufactured by Oji Scientific Instruments Co., Ltd.).

When a film to be measured is represented by a uniaxial or biaxial refractive index ellipsoid, Rth (λ) is calculated by the following method.

A total of six points of the Re (λ) are measured by irradiating with an incident light with a wavelength of λ nm from each of the inclined directions at an angle increasing in 10° step increments up to 50° in one direction from the normal direction with respect to the normal direction of the film by using the in-plane slow axis (decided by KOBRA 21ADH or WR) as an inclined axis (rotation axis) (when there is no slow axis, any in-plane direction of the film is used as a rotation axis), and then Rth (λ) is calculated by KOBRA 21ADH or WR based on the retardation value measured, a hypothetical value of an average refractive index, and an inputted film thickness value.

In the above, in the case of a film having a direction in which a retardation value is zero at a certain inclined angle with the in-plane slow axis from the normal direction being a rotation axis, a retardation value at an inclined angle larger than the inclined angle is changed into a sign of a negative value and then calculated by KOBRA 21ADH or WR.

Furthermore, with the slow axis as an inclined axis (rotation axis) (when there is no slow axis, any in-plane direction of the film is used as a rotation axis), retardation values may be measured from any two inclined directions and Rth may be calculated from the following equations (A) and (B) based on the values, a hypothetical value of an average refractive index and an inputted film thickness value.

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad Equation ( A )$$

The above-described Re (θ) represents a retardation value in a direction inclined at an angle (θ) from the normal direction.

In Equation (A), nx represents a refractive index in an in-plane slow axis direction, ny represents a refractive index in an in-plane direction perpendicular to nx, and nz represents a refractive index in a direction perpendicular to nx and ny. d is a film thickness.

Rth=((nx+ny)/2−nz)×d Equation (B)

In Equation (B), nx represents a refractive index in an in-plane slow axis direction, ny represents a refractive index in an in-plane direction perpendicular to nx, and nz represents a refractive index in a direction perpendicular to nx and ny. d is a film thickness.

In the case where a film to be measured may not be represented by a uniaxial or biaxial refractive index ellipsoid, a so-called film having no optic axis, Rth (λ) is calculated by the following method.

Eleven points of the Re (λ) are measured by irradiating with an incident light at a wavelength of λ nm from each of the inclined directions at an angle increasing in 10° step increments from −50° to +50° with respect to the normal direction of the film by using the in-plane slow axis (decided by KOBRA 21ADH or WR) as an inclined axis (rotation axis), and then Rth (λ) is calculated by KOBRA 21ADH or WR based on the retardation value measured, a hypothetical value of an average refractive index, and an inputted film thickness value.

In the above-described measurements, the values described in Polymer Handbook (John Wiley & Sons, Inc.) and catalogues of various optical films may be used as the hypothetical value of the average refractive index.

The average refractive index of which value is not already known may be measured by an Abbe refractometer. The values of average refractive index of main optical films are illustrated as follows:

Cellulose acylate (1.48), cycloolefin polymer (1.52), polycarbonate (1.59), polymethyl methacrylate (1.49) and polystyrene (1.59).

By inputting these hypothetical values of an average refractive index and the film thickness, KOBRA 21ADH or WR calculates nx, ny and nz.

Further, in the present specification, the measurement wavelength is 550 nm unless otherwise particularly rejected.

(Cellulose Ester Film)

Generally, a retardation film having an optically anisotropic layer formed on a polymer film has a patterning cycle in pixel unit when used for circular polarized light or linear polarized light glasses type for 3D display. In this case, for example, when a display is turned ON, the surface temperature of the display may be increased by the heat discharged from a backlight, thereby causing a dimensional change of the polymer film. Due to the dimensional change, a misalignment of pixels occurs, and thus, so-called crosstalk is generated, in which an image for the right eye is recognized by the left eye or an image for the left eye is recognized by the right eye. Therefore, it is preferred to suppress the dimensional change of the polymer film.

In a cellulose ester film of the present invention (hereinafter, referred to as the film of the present invention), a ratio of a sound velocity in a width direction to a sound velocity in a longitudinal direction is 0.9 to 1.1, moist heat dimensional change rate in the width direction is −0.2% to 0.2% after left standing at 60° C. and 90% RH for 24 hours, and humidity dimensional change rate in the width direction is 0.38% or less.

Hereinafter, the film of the present invention will be described.

<Cellulose Ester>

As the cellulose ester powder or particle type may be used, and pelletized type may also be used.

The cellulose ester film of the present invention may be composed of one or two kinds of cellulose ester.

The cellulose ester is preferably cellulose acylate.

A cellulose acylate resin used in the present invention is not particularly limited. Examples of the cellulose as an acylate raw material include cotton linter, wood pulp (broad leaf pulp, and needle leaf pulp) and the like, and a cellulose acylate obtained from any raw material cellulose may be used. In some cases, mixtures thereof may be also used. Detailed descriptions on these raw material celluloses may be found in, for example, “Lecture on Plastic Materials (17) Cellulose Resins” (written by Maruzawa, Uda, The NIKKAN KOGYO SHIMBUN, Ltd., published in 1970) or Japan Institute of Invention and Innovation, Open Technical Report No. 2001-1745 (pages 7 to 8).

First, cellulose acylate preferably used in the present invention is described in detail. The β-1,4 bonding glucose unit constituting cellulose contains free hydroxyl groups at 2-, 3- and 6-positions. Cellulose acylate is a polymer prepared by subjecting a part or the whole of these hydroxyl groups to further esterification with an acyl group having two carbon atoms or more. The degree of acyl substitution means the ratio of esterified hydroxyl groups in cellulose at each of 2-, 3- and 6-positions (100% esterification is defined as a degree of substitution of 1).

The total degree of acyl substitution, that is, DS2+DS3+DS6 is preferably from 1.5 to 3.0, more preferably from 2.0 to 3.0, even more preferably from 2.5 to 3.0, and particularly preferably from 2.7 to 2.98. In addition, from the viewpoint of film-forming property, in some cases, the total degree of acyl substitution is preferably from 2.80 to 2.95, and also particularly preferably from 2.85 to 2.90. Herein, DS2 is a degree of substitution of hydroxyl groups at 2-position of the glucose unit with acyl groups (hereinafter, also referred to as “degree of acyl substitution at 2-position”), DS3 is a degree of substitution of hydroxyl groups at 3-position with acyl groups (hereinafter, also referred to as “degree of acyl substitution at 3-position”), and DS6 is a degree of substitution of hydroxyl groups at 6-position with acyl groups (hereinafter, also referred to as “degree of acyl substitution at 6-position”). Furthermore, DS6/(DS2+DS3+DS6) is a ratio of the degree of acyl substitution at 6-position to the total degree of acyl substitution, and hereinafter will be also referred to as “ratio of acyl substitution at 6-position”.

For these celluloses, reference can be made to the descriptions from paragraph [0034] to paragraph [0039], International Publication No. 2011/102492.

The cellulose ester according to the present invention may have a moisture permeability of preferable 0.5% or more. The moisture permeability of a polymer may be controlled by adjusting the chemical structure of a polymer to be described below, and it is possible to control the moisture absorption expansion coefficient of a film by appropriately setting the moisture permeability. The relationship between moisture permeability and moisture absorption expansion coefficient is changed by the interaction intensity of polymers in a film, such as, for example, degree of crystallinity, molecular weight and degree of entanglement, and thus, it is impossible to uniformly correspond therebetween, but, generally speaking, the moisture absorption coefficient may be increased as the moisture permeability is increased by increasing the hydrophilicity of the polymer as described below.

The moisture permeability of the polymer is set at 0.5% or more. The moisture permeability is preferably 0.7%, and more preferably 1.0% or more. Furthermore, the upper limit thereof is not particularly limited, but from the viewpoint of practicality, the upper limit is preferably 10% or less, and more preferably 7.0% or less.

A film sample with a size of 7 mm×35 mm is measured with a moisture measuring apparatus and a sample drying apparatus “CA-03” and “VA-05” (manufactured by Mitsubishi Chemical Corporation) by the Karl Fischer method as a method for measuring the moisture permeability. The measured amount of moisture (g) may be divided by the sample mass (g) to give a moisture content.

<Additives>

Any additives may be added to cellulose ester film of the present invention. The additives may assist in controlling humidity dimensional change rate. Molecular weight of the additives is not particularly limited, but the following additives may be preferably used.

Besides the control of the humidity dimensional change rate, by adding the additives, useful effect may be obtained from the viewpoint of film modification such as a improvement in a thermal property, an optical property and a mechanical property, rendering a flexibility, rendering an absorption resistance, and a reduction of moisture permeability

From the viewpoint of manifesting various effects as described above, the amount of the additives added is preferably 10% by mass or more, more preferably 15% by mass or more, and most preferably 20% by mass or more, based on the cellulose ester. The upper limit is preferably 80% by mass or less, and more preferably 6% by mass or less. In case of using two or more additives, it is preferred the total amount is within the above range.

In order to control the mechanical properties, for example, a plasticizer may be added to the film. Examples of the plasticizer include various ester-based plasticizers such as phosphate ester, citrate ester, ester trimelitate and sugar ester, or polyester-based polymers as described in paragraph [0042] to paragraph [0068] of international Publication No. 2011/102492.

In addition, for rendering absorptivity of infrared or ultraviolet ray to control optical properties, reference may be made to paragraph [0069] to paragraph [0072] of International Publication No. 2011/102492. In order to adjust film retardation or control the manifestation, previously well-known retardation controlling agent may be used.

[Preparation of Cellulose Ester Film]

A method for preparing the cellulose ester film of the present invention will be described. Hereinafter, cellulose acylate will be described as an example, but other cellulose ester films may be formed in the same manner.

The film containing cellulose acylate may be formed by a solution casting film-forming method or a melting film-forming method

(Polymer Solution)

In the solution casting film forming method, a web is formed by using the cellulose acylate or a polymer solution (a cellulose acylate solution) containing various additives if necessary. Hereinafter, a polymer solution (hereinafter, appropriately referred to as a cellulose acylate solution in some cases) in the present invention, which may be used in the solution casting film forming method, will be described.

As a main solvent of the polymer solution in the present invention, an organic solvent which is a good solvent of cellulose acylate may be preferably used. As the organic solvent, an organic solvent with a boiling temperature of 80° C. or lower is more preferred from the viewpoint of reduction in dry load. The boiling temperature of the organic solvent is more preferably from 10° C. to 80° C., and particularly preferably from 20° C. to 60° C. In addition, in some cases, an organic solvent having a boiling temperature of from 30° C. to 45° C. may also be appropriately used as the main solvent. In the present invention, among the group of solvents as described below, particularly halogenated hydrocarbons may be preferably used as a main solvent. Among the halogenated hydrocarbons, chlorinated hydrocarbon is preferred, dichloromethane and chloroform are more preferred, and dichloromethane is most preferred. Furthermore, a solvent having a small ratio of volatilizing at the same time as a halogenated hydrocarbon in the initial stage of the drying process and having a boiling temperature of the gradually concentrated solvent of 95° C. or higher, may be contained in an amount of from 1% by mass to 15% by mass, preferably in an amount of from 1% by mass to 10% by mass, and more preferably in an amount of from 1.5% by mass to 8% by mass, based on the entire solvent. Moreover, a solvent having a boiling temperature of 95° C. or higher is preferably a poor solvent of cellulose acylate. Specific examples of the solvents having a boiling temperature of 95° C. or higher include solvents having a boiling temperature of 95° C. or higher among the specific examples of “organic solvent used in combination of the main solvent”. However, among them, butanol, pentanol and 1,4-dioxane are preferably used. Further, the solvent in the polymer solution of the present invention contains alcohol in an amount of 5% by mass to 40% by mass, preferably 10% by mass to 30% by mass, more preferably from 12% by mass to 25% by mass, and even more preferably from 15% by mass to 25% by mass. Specific examples of the alcohol herein used include solvents exemplified as an alcohol of “organic solvent used in combination with the main solvent” as described below. However, among them, methanol, ethanol, propanol and butanol are preferably used. In addition, when the above-described “solvent having a boiling temperature of 95° C. or higher” is an alcohol such as butanol and the like, the content thereof is also calculated as the alcohol content which is referred to herein. The mechanical strength of the cellulose acylate film manufactured at the heat treatment temperature may be increased by using the solvent, and thus, the film obtained by being stretched more than necessary during the heat treatment may be prevented from being easily broken.

Examples of the main solvent include particularly preferably a halogenated hydrocarbon, and include ester, ketone, ether, alcohol, a hydrocarbon and the like in some cases. The compounds may include a branched structure or a cyclic structure. Furthermore, the main solvent may have any two or more functional groups of ester, ketone, ether and alcohol (that is, —O—, —CO—, —COO— and —OH). Further, hydrogen atoms in the hydrocarbon moiety of the ester, ketone, ether and alcohol may be substituted with a halogen atom (particularly, fluorine atom). In addition, the main solvent of the polymer solution in the present invention, which is used in the manufacture of a cellulose acylate film used in the preparation method of the present invention, represents a single solvent when the solvent consists of the single polymer, and represents a solvent having the highest mass fraction among the constituent solvents when the solvent consists of a plurality of solvents. Examples of the main solvent appropriately include a halogenated hydrocarbon.

As the halogenated hydrocarbon, a chlorinated hydrocarbon is more preferred, and examples thereof include dichloromethane, chloroform and the like. Dichloromethane is even more preferred.

Examples of the ester include methyl formate, ethyl formate, methyl acetate, ethyl acetate and the like.

Examples of the ketone include acetone, methyl ethyl ketone and the like.

Examples of the ether include diethyl ether, methyl-tert-butyl ether, diisopropyl ether, dimethoxymethane, 1,3-dioxolan, 4-methyldioxolan, tetrahydrofuran, methyltetrahydrofuran, 1,4-dioxane and the like.

Examples of the alcohol include methanol, ethanol, 2-propanol and the like.

Examples of the hydrocarbon include n-pentane, cyclohexane, n-hexane, benzene, toluene and the like.

Examples of an organic solvent used in combination with these main solvents include a halogenated hydrocarbon, ester, ketone, ether, alcohol, a hydrocarbon and the like. These compounds may have a branched structure or a cyclic structure. In addition, the organic solvent may have any two or more functional groups of ester, ketone, ether and alcohol (that is, —O—, —CO—, —COO— and —OH). Furthermore, hydrogen atoms in the hydrocarbon moiety of the ester, ketone, ether and alcohol may be substituted with a halogen atom (particularly, fluorine atom).

As the halogenated hydrocarbon, a chlorinated hydrocarbon is more preferred, and examples thereof include dichloromethane, chloroform and the like. Dichloromethane is even more preferred.

Examples of the ester include methyl formate, ethyl formate, prophyl formate, pentyl formate, methyl acetate, ethyl acetate, pentyl acetate and the like.

Examples of the ketone include acetone, methyl ethyl ketone, diethyl ketone, diisobuthyl ketone, cyclopentanone, cyclohexanone, methylcyclohexanone and the like.

Examples of the eter include diethyl ether, methyl-tert-buthyleher, diisopropylether, dimethoxymethane, dimethoxyethane, 1,4-dioxane, 1,3-dioxolane, 4-methyldioxolane, tetrahydrofuran, methyltetrahydrofuran, anisol phenetol, phenetol and the like.

Examples of the alcohol include methanol, ethanol, 1-propanol, 2-propanol, 1-butanol, 2-butanol, tert-butanol, 1-pentanol, 2-methyl-2-butanol, cyclohexanol, 2-fluoroethanol, 2,2,2-trifluoroethanol, 2,2,3,3-tetrafluoro-1-propanol and the like. It is preferable to use alcohol having 1 to 4 carbon atoms, and more preferably methanol, ethanol or butanol, and most preferably methanol or butanol.

Examples of the hydrocarbon include n-pentane, cyclohexane, n-hexane, benzene, toluene, xylene and the like.

Examples of the organic solvent having two or more functional groups include 2-ethoxyethyl acetate, 2-methoxyethanol, 2-butoxyethanol, methylacetacetate and the like.

In the present invention, the polymer constituting a cellulose acylate film includes a hydrogen bonding functional group such as a hydroxyl group, ester, ketone and the like, and thus it is preferred that the entire solvent contains 5% by mass to 30% by mass, more preferably 7% by mass to 25% by mass and even more preferably 10% by mass to 20% by mass of alcohol from the viewpoint of reducing the load of peeling-off from a casting support.

The expression of Re or Rth of a cellulose acylate film prepared by the preparation method of the present invention may be easily adjusted by adjusting the content of alcohol. Specifically, as the content of alcohol is increased, it is possible to set the heat treatment temperature at a relatively low level or enhance the extent of Re or Rth.

Further, in the present invention, containing a small amount of water is also effective to increase the solution viscosity or the film strength in the state of a moist film during drying, or to increase the dope strength during a drum method casting. For example, water is contained in an amount of preferably 0.1% by mass to 5% by mass, more preferably 0.1% by mass to 3% by mass, and particularly preferably 0.2% by mass to 2% by mass, based on the entire solution.

Examples of combinations of organic solvents which are preferably used as a solvent of the polymer solution in the present invention are mentioned in Japanese Patent Application Laid-Open No. 2009-262551.

In addition, a non-halogen-based organic solvent may be used as the main solvent if necessary, and a detailed description thereof is described in Japan Institute of Invention and Innovation, Open Technical Report (Open Technical No. 2001-1745, published in Mar. 15, 2001, and Japan Institute of Invention and Innovation).

The concentration of cellulose acylate in the polymer solution in the present invention is preferably 5% by mass to 40% by mass, more preferably 10% by mass to 30% by mass, and most preferably 15% by mass to 30% by mass.

The concentration of cellulose acylate may be adjusted so as to be a predetermined concentration in the step of dissolving the cellulose acylate in the solvent. Furthermore, a solution at a low concentration (for example, 4% by mass to 14% by mass) is prepared in advance, and then the solution may be concentrated by evaporating the solvent and the like. Furthermore, a solution at a high concentration is prepared in advance, and then the solution may be diluted. Further, the concentration of cellulose acylate may be reduced by adding an additive thereto.

The time at which an additive is added thereto may be appropriately determined according to the kind of the additive.

It is preferred that no additives used in the cellulose acylate film of the present invention are substantially volatilized during the drying process. As the amount of the additive added is increased, problems such as reduction in glass transition temperature of the polymer film or volatilization of the additive in the preparation process of the film are easily caused, and thus, the amount of the additive having a molecular weight of 3,000 or less is preferably 0.01% by mass to 30% by mass, more preferably 2% by mass to 30% by mass, and even more preferably 5% by mass to 20% by mass, based on the polymer.

(Preparation of Polymer Solution)

The preparation of the polymer solution in the present invention may be performed in accordance with, for example, Japanese Patent Application Laid-Open Nos. S58-127737 and S61-106628, Japanese Patent Application Laid-Open Nos. H2-276830, H4-259511, H5-163301, H9-95544, H10-45950, H10-95854, H11-71463, H11-302388, H11-322946, H11-322947 and H11-323017, and Japanese Patent Application Laid-Open Nos. 2000-53784, 2000-273184 and 2000-273239. Specifically, the polymer solution in the present invention is obtained by mixing a polymer and a solvent and stirring the mixture to swell the mixture, cooling or heating the mixture in some cases to dissolve the mixture, and then filtering the mixture.

In order to improve the solubility of the polymer in the solvent in the present invention, it is preferred that a process of cooling and/or heating the mixture of the polymer and the solvent is included.

When a halogen-based organic solvent is used as the solvent to cool the mixture of cellulose acylate and the solvent, it is preferred to include a process of cooling the mixture to −100° C. to 10° C. Furthermore, it is preferred to include a process of swelling the mixture at −10° C. to 39° C. in a process before the cooling process and include a process of warming the mixture to 0° C. to 39° C. in a process after the cooling.

When a halogen-based organic solvent is used as the solvent to heat the mixture of cellulose acylate and the solvent, it is preferred to include a process of dissolving cellulose acylate in the solvent by one or more methods selected from the following (a) or (b).

(a) Swelling is performed at from −10° C. to 39° C., the obtained mixture is warmed to from 0° C. to 39° C.

(b) Swelling is performed at from −10° C. to 39° C., the obtained mixture is heated to from 40° C. to 240° C. at from 0.2 MPa to 30 MPa, and the heated mixture is cooled to from 0° C. to 39° C.

Further, when a non-halogen-based organic solvent is used as the solvent to cool the mixture of cellulose acylate and the solvent, it is preferred to include a process of cooling the mixture to from −100° C. to 10° C. is included. In addition, it is preferred to include a process of swelling the mixture at from −10° C. to 55° C. in a process before the cooling process and include a process of warming the mixture to from 0° C. to 57° C. in a process after the cooling.

When a halogen-based organic solvent is used as the solvent to heat the mixture of cellulose acylate and the solvent, it is preferred to include a process of dissolving cellulose acylate in the solvent by one or more methods selected from the following (c) or (d) is included.

(c) Swelling is performed at from −10° C. to 55° C., the obtained mixture is warmed to from 0° C. to 57° C.

(b) Swelling is performed at from −10° C. to 55° C., the obtained mixture is heated to from 40° C. to 240° C. at from 0.2 MPa to 30 MPa, and the heated mixture is cooled to from 0° C. to 57° C.

(Film Formation of Web)

The web in the present invention may be formed by a solution casting film forming method using the polymer solution in the present invention. In carrying out the solution casting film forming method, an apparatus known in the art may be used according to a method in the related art. Specifically, a dope (polymer solution in the present invention) prepared in a dissolver (tank) is filtered and once stored in a storage tank, and bubbles included in the dope is defoamed to prepare the dope finally. The dope is kept warm at 30° C., and sent from a dope outlet to a pressurized die, for example, through a pressurized metering gear pump which may perform quantitative solution sending with a high degree of accuracy by revolutions. The dope is uniformly cast from an inlet member (slit) of the pressurized die onto a metal support of a casting unit running endlessly (a dope casting process). Subsequently, a half-dry dope film (web) is peeled off from the metal support at a peeling-off point where the metal support has approximately gone round, and subsequently conveyed to a drying zone to terminate drying while conveying with a group of rolls. Details of the casting process and the drying process of the solution casting film forming method are described also in Japanese Patent Application Laid-Open No. 2005-104148, pages 120 to 146, and may also be appropriately applied to the invention.

In the present invention, as the metal support used in the film formation of the web, a metal band or a metal drum may be used.

(Stretching Process)

The method for preparing the cellulose ester film according to the present invention includes a process of stretching entire film including the cellulose ester in a specific direction. In the cellulose ester film according to the present invention, a heat expansion coefficient and a humidity dimensional change rate in a stretching direction may be reduced by stretching. Stretching may be performed at 10% to 40% in the width direction, which is perpendicular to the longitudinal direction (corresponding to the conveying direction). In addition, it is also possible to perform a biaxial-stretching, in combination with stretching in a direction discordant with the width direction (for example, the longitudinal direction).

The stretching magnification in the width direction is 10 to 40%, and preferably 15 to 40%.

In addition, the stretching in the longitudinal direction is 0 to 20%, preferably 0 to 10%, and much more preferably 0 to 5%.

For a method for controlling the anisotropic property of the elastic modulus by performing stretching without increasing the haze of a film, a stretching method, including: performing stretching under a specific condition, which is described in Japanese Patent Application Laid-Open No. 2007-176164 and the like, or a stretching method, including: first increasing the haze and then reducing the haze, which is described in Japanese Patent Application Laid-Open No. 2009-137289 and the like, may be preferably used. In addition, for a method for controlling the anisotropic property of the elastic modulus by performing stretching while the solvent remains in the film, a stretching method described in Japanese Patent Application Laid-Open No. 2007-119717 and the like may be preferably used.

Furthermore, “stretching magnification (%)” used in the present specification means obtaining the stretching magnification by the following equation.

Stretching magnification(%)=100×{(length after stretching)−(length before stretching)}/length before stretching

Further, the stretching speed of the web in the stretching process is not particularly limited, but is preferably from 1%/min to 1,000%/min, and more preferably from 1%/min to 100%/min from the viewpoint of stretching suitability (wrinkles, handling and the like). The stretching may be performed in a single step or may be performed in multiple steps. Furthermore, the stretching may be imposed in a direction (transverse direction) going straight to a conveying direction.

The web subjected to the stretching process is subsequently conveyed into a drying zone, and then the drying process may be performed after the stretching process. In the drying process, the web is dried by the tenter having clips while being fixed at both edges thereof or while conveying with a group of rolls.

[Humidity Dimensional Change Rate]

When measuring the humidity dimensional change rate of the cellulose acylate film in the present invention, the width direction of the film is regarded as a measurement direction, and then, a film sample is cut so as to have 12 cm long in the measurement direction and 3 cm width. Pin holes are drilled at an interval of 20 cm on the sample, humidity is controlled at 25° C. and 10% relative humidity (RH) for 24 hours, and then the interval of the pin holes is measured by a pin gauge (the measured value L₀). Subsequently, the sample is humidity conditioned at 25° C. and 80% RH for 24 hours, and the interval of the pin holes is measured (the measured value L₁). The humidity dimensional change rate is calculated by the following equation using the measured value.

Humidity dimensional change rate[%]=(L₁−L₀)*100/L₀

The humidity dimensional change rate in the width direction of the cellulose ester film of the present invention may be 0.38% or less, more preferably 0% to 0.35%, and most preferably 0% to 0.30%.

The width direction variation of the humidity dimensional change rate may be preferably 10% or less, more preferably 0% to 7%, and most preferably 0% to 5%.

Herein, the variation of humidity dimensional change rate is calculated by measuring the humidity dimensional changes in five places that are selected so as to be uniform interval in the width direction, and then dividing the difference between the maximum value and the minimum value by the average humidity dimensional change rate of the five places.

Since a great variation of the humidity dimensional change rate causes a great local difference of the humidity dimensional change, the optically anisotropic layer to be layered product follows such a deformation. Therefore, in the case where the optically anisotropic layer is formed in pattern type, the deterioration of display performance is emphasized as pattern deformation easily occurs. It is presumed that the variation of the humidity dimensional change rate is caused by the ununiform state of the molecular chain in the film, owing to variation of the film temperature or the amount of a solvent within the range of the region subjected to stretching in the width direction. In the present invention, since conditions of stretching are equalized for the purpose of suppressing residual stress (for example, it is preferred to uniform dry wind volume and dry wind temperature in the width direction), it is recognize that uniformity of the state of molecular chain is improved, and thus, the free volume variation for moisture or solvent is reduced. and the variation in the width direction of the humidity dimensional change rate is reduced.

[Sound Velocity]

In the present invention, a sound velocity of the cellulose ester film in the width direction and in the longitudinal direction can be measured after humidity-controlling the film at 25° C. and 60% RH for 24 hours using an alignment-property meter (SST-2500: manufactured by Nomura Shoji Co., Ltd.). From the result of the measurement, the ratio of the sound velocity in the width direction to the sound velocity in the longitudinal direction can be calculated.

For cellulose ester film of the present invention, the ratio of sound velocity in the width direction to the sound velocity in the longitudinal direction is set to be 0.9 to 1.1, and preferably 0.95 to 1.10. Residual stress of the films within these ranges is suppressed, and thus, moist heat dimensional change may be suppressed.

[Moist Heat Dimensional Change Rate]

When measuring moist heat dimensional change rate of the cellulose acylate film in the present invention, any one direction of the film is regarded as a measurement direction, and then, a film sample is cut so as to have 12 cm long in the measurement direction and 3 cm width. Pin holes are drilled at an interval of 20 cm on the sample, humidity is controlled at 25° C. and 10% relative humidity (RH) for 24 hours, and then the interval of the pin holes is measured by a pin gauge (the measured value L₁₀). Subsequently, the sample is left standing at 60° C. and 90% RH for 24 hours, then, 25° C. and 60% RH for 2 hours, and the interval of the pin holes is measured (the measured value L₁₁). The moist heat dimensional change rate is calculated by the following equation using the measured value.

Moist heat dimensional change rate[%]=(L₁₁−L₁₀)*100/L₁₀

The moist heat dimensional change rate of the cellulose ester film in the present invention is −0.2% to 0.2%, and preferably −0.15% to 0.15%.

[Retardation of Cellulose Ester Film]

The cellulose ester film of the present invention may preferably have an in-plane retardation (in-plane retardation), Re, of 0 nm to 5 nm and a thickness-direction retardation, Rth, of 0 nm to 50 nm, because an optical influence on the pattern retardation layer may be reduced when pattern retardation layer is formed on the film.

[Width of Cellulose Ester Film]

The cellulose ester film of the present invention has a film width of preferably 1.8 m or more, more preferably 1.9 m to 4 m, and even more preferably 2.2 m to 3 m.

(Layered Product)

The layered product of the present invention has an optically anisotropic layer on at least one side of the cellulose ester film. The layered product may be used as an optical film having retardation (for example, retardation film).

The optically anisotropic layer may be formed by various forming methods as described below as a method for forming a pattern retardation layer, but, it is preferred to form by coating.

(Pattern Retardation Layer)

A preferred aspect of the optically anisotropic layer is an aspect having multiple regions having different refractive indices and a pattern type arrangement in the longitudinal direction (the optically anisotropic layer of this aspect is also referred to as pattern retardation layer).

Further, a longitudinal direction of a pattern (a direction of a long side of the pattern) in patterning may be approximately perpendicular to or approximately parallel to the maximum sound velocity direction of the support, but is preferably approximately perpendicular to the direction from the viewpoint of suppressing the change in size.

In addition, from the viewpoint that roll-to-roll may be readily achieved and wrinkles are not easily generated, the directions are preferably approximately parallel to each other.

In the pattern retardation layer, it is preferred that a first retardation region (simply referred to as a first region) and a second retardation region (simply referred to as a second region) alternately aligned in the width direction. Examples of the first retardation region and the second retardation region may include an aspect with different refractive indices or an aspect with different slow axis directions.

(Shapes of First Region and Second Region)

It is preferred that the first retardation region and the second retardation region are alternatively patterned for every one line. It is preferred that the first region and the second region have a belt-like shape with the lengths of the short sides of the regions almost identical to each other, and are repetitively and alternately patterned from the viewpoint of being used for a 3D stereoscopic image display system.

For the layered product of the present invention, it is preferred that the slow axis of the first region and the slow axis of the second region are approximately perpendicular to each other from the viewpoint that the polarization state of light passed through the first region and the second region may be switched from the linearly polarized light to the circularly polarized light or from the circularly polarized light to the linearly polarized light.

Further, for the layered product of the present invention, it is more preferred that the slow axis of the first region and the slow axis of the second region are perpendicular to each other from the viewpoint that the polarization state of light passed through the first region and the second region may be switched from the linearly polarized light to the circularly polarized light or from the circularly polarized light to the linearly polarized light, without being elliptically polarized.

For the layered product of the present invention, it is preferred that the direction of the long side of the pattern and the direction in which the sound velocity of the support becomes the maximum are approximately perpendicular to each other from the viewpoint that the misalignment of the pattern region and the pixel may be reduced and the crosstalk may be suppressed.

(Retardation)

As described above, it is preferred that a pattern retardation layer having a function of converting the linearly polarized light into the circularly polarized light, or the circularly polarized light into the linearly polarized light has a ¼ retardation of the wavelength. In general, the retardation is called as a ¼ wavelength plate, and at a visible light wavelength of 550 nm, Re=137.5 nm becomes an ideal value.

In addition, a pattern retardation layer of converting the linearly polarized light into the circularly polarized light or the circularly polarized light into the linearly polarized light does not always have a ¼ retardation. For example, the retardation may be a −¼ or ¾ retardation of the wavelength, and if the relationship is expressed by a general formula, the retardation may have a ¼±n/2 (n is an integer) retardation of the wavelength.

For the patterning in which the slow axis of the first region and the slow axis of the second region are perpendicular to each other, it is preferred that regions having a −¼ or ¼ retardation of the wavelength may be alternately formed. At this time, the slow axes of the respective regions are almost perpendicular to each other. Furthermore, ¼ and ¾ retardations of the wavelength may be patterned, and at this time, the slow axes of the respective regions are almost parallel to each other. However, the rotation directions of the circularly polarized light of the respective regions are opposite to each other.

Furthermore, for the patterning of the ¼ and ¾ retardation of the wavelength, ½ or −½ retardation of the wavelength may be formed after the ¼ of the wavelength is formed on the entire surface.

When the optical film of the present invention has the ¼ retardation of the wavelength, a Re (550) value of the first region included in the optical film and a Re (550) value of the second region included in the optical film are preferably from 30 nm to 250 nm, more preferably from 50 nm to 230 nm, particularly preferably from 100 nm to 200 nm, more particularly preferably from 105 nm to 180 nm, even more preferably from 115 nm to 160 nm, and more particularly preferably from 130 nm to 150 nm.

Further, during the 3D image display, the entire Re (550) of the pattern retardation layer and the support is preferably from 110 nm to 165 nm, more preferably from 110 nm to 155 nm, and even more preferably from 120 nm to 145 nm from the viewpoint that the polarization state of light passed through the first region and the second region may be switched from the linearly polarized light to the circularly polarized light or from the circularly polarized light to the linearly polarized light. In particular, it is preferred that the entire Re (550) of the pattern retardation layer and the support is within the range, and the slow axes of the first regions and the second regions are approximately perpendicular to each other from the viewpoint that the accuracy is good and the polarization state of an image for the right eye and an image for the left eye may be changed.

(Pattern Forming Method)

The first region and the second region may be formed by various methods. Hereinafter, examples of the method will be illustrated, but the present invention is not limited thereto.

[Pattern Exposure]

For patterning the retardation layer, pattern exposure may be performed.

The pattern exposure means that exposures which are different in mutual exposure conditions are performed on two or more regions of materials for manufacturing a birefringence pattern. At this time, “two or more regions” may or may not have a mutually overlapping site, but it is preferred that the regions do not have a mutually overlapping site. The pattern exposure may be a pattern exposure which produces only an exposed portion and an unexposed portion. In this case, a region on which a retardation is usually to be imposed is exposed. In addition, the pattern exposure may be a pattern exposure including an exposed portion produced by one or more exposure conditions, which is a middle tone of the unexposed portion and the exposed portion. The pattern exposure may be performed by one exposure, or may be performed by a plurality of exposures. For example, the pattern exposure may be performed by using one exposure using a mask which has two or more regions showing different transmission spectra by the region, or both may be combined.

The exposure condition is not particularly limited, but may include exposure peak wavelength, exposure illumination, exposure time, exposure value, temperature during exposure, atmosphere during exposure and the like. Among them, from the viewpoint of the ease of adjusting conditions, exposure peak wavelength, exposure illumination, exposure time and exposure value are preferred, and exposure illumination, exposure time and exposure value are more preferred. Then, the regions exposed under different exposure conditions during pattern exposure are subjected to baking, and thus, are different from each other, and show birefringence controlled by exposure conditions. In particular, a different amount of retardation is imparted. Furthermore, the exposure conditions between two or more exposure regions exposed under different exposure conditions may be discontinuously changed or continuously changed.

[Mask Exposure]

As a means for generating exposure regions which are different in exposure conditions, exposure using an exposure mask is useful. For example, exposure conditions of a previously exposed region and a later exposed region may be easily changed by performing exposure using an exposure mask to expose only one region, and then performing an exposure using separate masks by changing temperature, atmosphere, exposure illumination, exposure time and exposure wavelength, or performing an entire surface exposure. Furthermore, as a mask for changing exposure illumination or exposure wavelength, a mask having two or more regions which show different transmission spectra according to the region is particularly useful. In this case, by performing exposure only once, exposure may be performed on a plurality of regions at different exposure illuminations or exposure wavelengths. It is understood that different exposure values may be imparted by performing exposure at different exposure illuminations for the same time.

Further, when the scanning exposure using laser and the like is used, it is possible to change the exposure conditions for each region by a technique such as changing the intensity of a light source according to the exposure region and changing the scanning speed.

The technique of pattern exposure may be the contact exposure, the proximity exposure, the projection exposure and the like, and may be the direct drawing obtained by focusing laser, electronic beam or the like on a predetermined position without a mask. The irradiation wavelength of the light source of the exposure is preferably a peak wavelength of from 250 nm to 450 nm, and more preferably from 300 nm to 410 nm. When step heights are simultaneously formed by a photosensitive resin layer, it is preferred that light in a wavelength region that may cure the resin layer (for example, 365 nm, 405 nm and the like) is irradiated. Specifically, a super high pressure mercury lamp, a high pressure mercury lamp, a metal halide lamp, blue laser and the like may be used. A preferred exposure value is usually from 3 mJ/cm² to 2,000 mJ/cm², more preferably from 5 mJ/cm² to 1,000 mJ/cm², even more preferably from 10 mJ/cm² to 500 mJ/cm², and most preferably from 10 mJ/cm² to 100 mJ/cm².

[Heating (Bake)]

The patterning of a retardation amount is performed as a pattern according to the exposure condition during the pattern exposure by performing bake on the pattern exposed retardation layer at from 50° C. to 400° C. When the retardation dissipation temperature before the exposure of the retardation layer used and the retardation dissipation temperature after the exposure are assigned as T1 [° C.] and T2 [° C.] (when there is no retardation dissipation temperature at a temperature range of 250° C. or lower, T2=250° C.), the temperature during the bake is preferably from T1° C. to T2° C., more preferably from (T1+10)° C. to (T2−5)° C., and most preferably from (T1+20)° C. to (T2−10)° C.

In the case of using a retardation layer in which the retardation dissipation temperature is increasing, the retardation of the unexposed portion in the layer is reduced by the bake, by performing exposure while the reduction in retardation in the exposed portion is small or retardation is not reduced, or the retardation increases. As a result, the retardation in the unexposed portion is smaller than the retardation in the exposed portion, whether there is an axis or not is determined, or a pattern of the amount of retardation is prepared.

[Patterning in Axis Direction]

The method of patterning in an axis direction is not particularly limited, but a patterning in a direction of a light axis (slow axis) of the retardation layer may be performed preferably by using an orientation layer.

When a layer including a liquid crystalline compound provided on a light orientation layer, preferably a layer including a liquid crystalline compound directly provided on a light orientation layer, is irradiated by ultraviolet light, liquid crystal molecules are oriented in a polarized light direction of a polarized ultraviolet light on the light orientation layer prepared. Likewise, when a layer including a liquid crystalline compound provided on a rubbing orientation layer, preferably a layer including a liquid crystalline compound directly mounted on a rubbing orientation layer, is irradiated by ultraviolet light, liquid crystal molecules are oriented in a direction of rubbing.

Accordingly, when a pattern retardation layer is provided on a light orientation layer, a polarized light ultraviolet light is pattern irradiated by a technique which is the same as a technique of pattern exposure used during preparation of the above-described pattern retardation layer on a layer formed from a composition for forming a light orientation layer, thereby patterning the light orientation of the layer. A retardation layer with an axis direction patterned may be obtained by coating, drying and the like a composition containing a liquid crystalline compound on the light orientation layer obtained, and then irradiating ultraviolet light thereon. Likewise, when a pattern retardation layer is provided on a rubbing orientation layer, rubbing is performed through a mask and the like on a layer which is formed by a composition for forming a rubbing orientation layer prior to rubbing, thereby patterning a rubbing direction of the layer. A retardation layer with an axis direction patterned may be obtained by coating, drying and the like a composition containing a liquid crystalline compound on the light orientation layer obtained, and then irradiating ultraviolet light thereon.

(Preparation Using Transfer Material)

The formation of the pattern retardation layer of the present invention may be performed by using transfer materials. The coating using organic solvents may be performed at a place different from a place where patterning materials are prepared by using transfer materials, and thus work and facility burdens when patterning materials are used are alleviated. Various transfer materials known in the art may be used, and transfer materials and the like described in, for example, paragraphs [0090] to [0097] of Japanese Patent Application Laid-Open No. 2009-223001 may be used.

[Formation of Optically Anisotropic Layer by Inkjet Method]

Subsequently, embodiments in which the optically anisotropic layer is formed in any shape by using an inkjet will be described.

As the present embodiment, a fluid such as a solution in which a predetermined optically anisotropic property is expressed and the like is discharged by using an inkjet apparatus to form a layer consisting of the fluid in a micro region (for example, a transverse line of display pixels is a belt-like shape for every one line). The fluid preferably contains at least one of liquid crystalline compounds. Among them, the fluid preferably contains at least one of compounds represented by Formula (I) or Formula (II) of Japanese Patent Application Laid-Open No. 2007-270686. It is preferred that the fluid is prepared such that the liquid crystalline phase is formed after drying. The fluid may be discharged by inkjet, or may use a liquid dispersion in which a part or the whole of materials such as the liquid crystalline compound and the like are dispersed. However, the fluid is preferably a solution.

Also in the present aspect, the optically anisotropic layer may be formed on an orientation film. That is, an orientation film is previously formed, and then the fluid may be discharged in a micro region of the orientation film. An orientation film available in the present embodiment is the same as examples of the orientation film available in embodiments of the transfer method. A method for forming the orientation film is not particularly limited, but as the present embodiment, it is preferred that the orientation film is formed by the inkjet method in the same manner as in the formation of the optically anisotropic layer. After the discharge of the fluid is completed, the layer of the fluid is dried as desired to form a liquid crystalline phase and cured by exposing the layer, thereby forming an optically anisotropic layer. In order to form the liquid crystalline phase, the layer may be heated as desired. In this case, a heating apparatus may be used.

The fluid is preferably curable. That is, it is preferred that a curable composition is prepared into a fluid such as a solution and the like. For a polymerization initiator contained in the curable composition, various polymerization initiators described as embodiments of the transfer method may be used. Further, the fluid may contain an additive such as an orientation controlling agent and the like, and examples thereof are also in the same manner as examples of various additives described in embodiments of the transfer method. In addition, examples of the solvent used in the preparation of the fluid are also in the same manner as in examples of solvents available in the preparation of the coating liquid as embodiments of the transfer method.

Injection conditions of ink and the like when the optically anisotropic layer is formed are not particularly limited, but when the viscosity of a fluid for forming an optically anisotropic layer is high, it is preferred that ink is injected while reducing the viscosity of ink at room temperature or under heating (for example, from 20° C. to 70° C.) from the viewpoint of injection stability. The change in viscosity of ink and the like impose great influence on liquid drop size and liquid drop injection speed as it is, and thus deterioration in image quality is caused. Therefore, it is preferred that the temperature of ink and the like is maintained at a constant level as much as possible.

An inkjet head (hereinafter, simply referred to as head) used in the method is not particularly limited, and various inkjet heads known in the art may be used. Continuous type and dot-on-demand type inkjet heads are available. Among the dot-on-demand type heads, for discharge, a thermal head is preferably a type having an operation valve described in Japanese Patent Application Laid-Open No. 9-323420. As a piezo head, heads described in EP No. A277,703, EP No. A278,590 and the like may be used. It is preferred that the head has a temperature controlling function such that temperature may be managed. It is preferred that the injection temperature is set in order to have an viscosity of from 5 mPa to 25 mPa when the fluid is injected and the fluid temperature is controlled to maintain a variation width of the viscosity within +5%. Furthermore, the driving frequency is preferably from 1 kHz to 500 kHz.

The layered product of the present invention is appropriate for use in particularly a large screen liquid crystal display device. When an optical film is used for a liquid crystal display device for a large screen, it is preferred that a film width is molded into, for example, 1,470 mm or more. In addition, the layered product of the present invention includes a film as an aspect of a film piece cut into a size capable of being incorporated into a liquid crystal display device as it is as well as a film having an aspect of a film manufactured into a long shape and wound up as a roll type. The film in the latter aspect is cut into a desired size and used when the film is stored and conveyed as it is and then actually incorporated into a liquid crystal display or adhered to a polarizer and the like. Furthermore, likewise, the film is adhered as a long shape to a polarization film consisting of a polyvinyl alcohol film and the like prepared into a long shape, and then is cut into a desired size and used when actually incorporated into a liquid crystal display device. As an aspect of the optical film wound up as a roll type, as an aspect in which the optical film is wound up into a roll type with a roll length of 2,500 m or more may be used.

[Polarizing Plate]

In a polarizing plate of the present invention, at least one sheet of the cellulose ester film or the layered product of the present invention is used as a protective film.

The polarizing plate may include a polarizing plate having a typical configuration known in the related art, and as a specific configuration of the polarizing plate, a known configuration may be adopted without any particular limitation. However, for example, a configuration in FIG. 6 of Japanese Patent Application Laid-Open No. 2008-262161 may be adopted. The layered product of the present invention may be prepared into a pattern retardation film which may be layered product on a surface on one side of a typical polarizing plate and used in a 3D stereoscopic image display system of a polarizing glasses mode. An aspect of the polarizing plate includes a polarizing plate having an aspect of a film piece cut into a size capable of being incorporated into a liquid crystal display device as it is as well as a polarizing plate having an aspect of a belt-like shape, that is, a film manufactured as a long shape by a continuous production and wound up into a roll type (for example, an aspect with a roll length of 2,500 m or more or 3900 m or more). As described above, it is preferred that the width of a polarizing plate is maintained at 1470 mm or more in order to be applied to a large screen liquid crystal display device.

[Adhesive Layer]

In the polarizing plate of the present invention, the cellulose ester film or the layered product and a polarization film may be layered product through an adhesive layer.

In the present invention, an adhesive layer used for lamination of the cellulose ester film or the layered product and a polarization film refers to, for example, a material with a ratio of G′ and G″ (tan δ=G″/G′) of from 0.001 to 1.5, and includes an adhesive, a material susceptible to creep, and the like.

[Image Display Panel]

An image display panel of the present invention includes at least one sheet of the cellulose ester film, the layered product or the polarizing plate of the present invention. In a preferred aspect, the cellulose ester film or the layered product of the present invention is used as a protective film disposed close to the side of visual recognition. Accordingly, in the case where the pattern retardation layer is formed, among lights in the image display panel, the polarization state of light passed through the first region and light passed through the second region may be switched, thereby obtaining an image display panel capable of displaying a 3D stereoscopic image display.

An image display panel used in an image display device of the present invention is not particularly limited, and may be a CRT or a flat panel display. However, a flat panel display is preferred. As the flat panel display, PDP, LCD, organic ELD and the like may be used, but the present invention may be particularly preferably applied when the image display panel is a liquid crystal display panel. Among flat panel displays, a high quality and inexpensive image display system may be obtained by manufacturing the image display panel as a liquid crystal display panel.

In a liquid crystal display device having a liquid crystal cell and a pair of polarizing plates disposed at both sides of the liquid crystal cell, it is preferred that at least one of the polarizing plates is the polarizing plate of the present invention, and the protective film of this polarizing plate, which is the cellulose ester film or the layered product, is disposed so as to be close to the side of visual recognition. Particularly, a liquid crystal display of IPS, OCB or VA mode is preferred.

A specific configuration of the liquid crystal display device is not particularly limited, but a known configuration may be adopted. Further, the configuration of FIG. 2 in Japanese Patent Application Laid-Open No. 2008-262161 may also be preferably adopted.

[Image Display System]

The cellulose ester film, the layered product, the polarizing plate or the liquid crystal display device of the present invention may be used for an image display system. Accordingly, for example, in the case where the pattern retardation layer is formed, the an image for the left eye and an image for the right eye are input into an image display panel, the image for the left eye and the image for the right eye are projected from an image display panel toward the optical film of the present invention, and the polarization states of the image for the left eye (or image for the right eye) passed through the first region of the pattern retardation layer of the present invention and the image for the right eye (or image for the left eye) passed through the second region may be switched. It is possible to obtain an image display system, through which an image for the left eye and an image for the right eye may be incident only on the left eye and the right eye, respectively, and a 3D stereoscopic image display may be observed, by using a pair of polarization glasses including a lens for the left eye including a polarizing plate which transmits only the image for the left eye passed through the first region and a lens for the right eye including a polarizing plate which transmits only the image for the right eye passed through the second region in combination.

The image display system is described in U.S. Pat. No. 5,327,285. Further, examples of the polarization glasses are described in Japanese Patent Application Laid-Open No. 10-232365.

In addition, a pattern retardation film in a commercially available image display system may be peeled off and then switched with the optical film of the present invention.

In the present invention, a preferred image display system may include the following liquid crystal display device. That is, the liquid crystal display device is a liquid crystal display device including: a pair of substrates having an electrode on at least one side thereof and disposed to face each other, a liquid crystal layer between the pair of substrates, a polarization film disposed to interpose the liquid crystal layer therebetween, a protective film installed at least on an external side of the polarization film, a first polarizing plate disposed on the side of a light source and a second polarizing plate disposed on the side of visual recognition, in which images are visually recognized through a third polarizing plate having the polarization film and at least one sheet of the protective film on the side of visual recognition of the second polarizing plate, and a liquid crystal display device using a polarizing plate having the layered product of the present invention as the second polarizing plate. The layered product of the present invention use a support having a small change in size according to the change in temperature, and thus a good 3D display performance may be obtained without a crosstalk even after time has elapsed.

Hereinafter, the present invention will be described in more detail with reference to Examples. Materials, reagents, material amounts and proportions thereof, operations and the like shown in the following Examples may be appropriately changed as long as the spirit of the present invention is not deviated therefrom. Accordingly, the scope of the present invention is not limited to the following specific Examples.

(Degree of Acetyl Substitution)

A degree of acetyl substitution of cellulose acylate was measured by the following methods.

A degree of acetyl substitution is measured in accordance with ASTM D-8,7-91. The viscosity-average degree of polymerization was measured by the extreme viscosity method of Uda et al. (Kazuo Uda and Hideo Saito, “Bulletin of The Society of Fiber Science and Technology, Japan”, vol. 18, No. 1, pp. 105-120 (1962)).

(Moist Heat Dimensional Change Rate)

A moist heat dimensional change rate of the cellulose acylate film was measured by the following method.

The winding direction of a film roll was regarded as a longitudinal direction (MD direction), and the width direction (TD direction) perpendicular to the longitudinal direction was regarded as a measurement direction, and then, a film sample was cut so as to have 12 cm long in the measurement direction and 3 cm width. Pin holes were drilled at an interval of 20 cm on the sample, humidity was controlled at 25° C. and 10% relative humidity (RH) for 24 hours, and then the interval of the pin holes was measured by a pin gauge (the measured value L₁₀). Subsequently, the sample was left standing at 60° C. and 90% RH for 24 hours, then, 25° C. and 60% RH for 2 hours, and the interval of the pin holes was measured (the measured value L₁₁). The moist heat dimensional change rate was calculated by the following equation using the measured value.

Moist heat dimensional change rate=(L₁₁−L₁₀)*100/L₁₀

(Humidity Dimensional Change Rate)

A humidity dimensional change rate of cellulose acylate film was measured by the following method.

The winding direction of a film roll was regarded as a longitudinal direction (MD direction), and the direction perpendicular to the longitudinal direction was regarded as a width direction (TD direction). The longitudinal direction or the width direction was regarded a measurement direction, and then, a film sample was cut so as to have 12 cm long in the measurement direction and 3 cm width. Pin holes were drilled at an interval of 20 cm on the sample, humidity was controlled at 25° C. and 10% relative humidity (RH) for 24 hours, and then the interval of the pin holes was measured by a pin gauge (the measured value L₀). Subsequently, the sample was humidity conditioned at 25° C. and 80% RH for 24 hours, and the interval of the pin holes was measured (the measured value L₁). The humidity dimensional change rate was calculated by the following equation using the measured value.

Humidity dimensional change rate[%]=(L₁−L₀)*100/L₀

(Sound Velocity)

A sound velocity (sonic wave propagation speed) of the cellulose ester film was measured after humidity-controlling the film at 25° C. and 60% RH for 24 hours using an alignment-property meter (SST-2500: manufactured by Nomura Shoji Co., Ltd.). The value when the meter was installed in parallel with the winding direction of the film roll, was designated as a longitudinal direction sound velocity (MD sound velocity), and the value when the meter was installed perpendicular to the winding direction of the film roll, was designated as a width direction sound velocity (TD sound velocity).

(Retardation)

An in-plane retardation Re and a thickness-direction retardation Rth of the cellulose acylate film were measured using KOBRA WR (manufactured by Oji Scientific Instruments Co., Ltd.).

1. Fabrication of retardation film

(Preparation of Film 1)

(1) Preparation of Dope for Intermediate Layer

Dope 1 for the intermediate layer was prepared in the following composition.

Composition of Dope 1

| | | |
|---|---|---|
| Cellulose acetate (degree of acetylation of 2.86) | 100 | parts by mass |
| Methylene chloride (first solvent) | 320 | parts by mass |
| Methanol (second solvent) | 83 | parts by mass |
| 1-butanol (third solvent) | 3 | parts by mass |
| Triphenyl phosphate | 7.6 | parts by mass |
| Biphenyl diphenyl phosphate | 3.8 | parts by mass |

Specifically, the preparation was performed in the following method.

Cellulose acetate powder (flake), triphenyl phosphate and biphenyl diphenyl phosphate were slowly added to a 4000 L stainless dissolving tank equipped with a stirring blade while stirring and dispersing the mixed solvent well to obtain a mixture having a total weight of 2000 kg. Meanwhile, a solvent having a water content of 0.5% by mass or less was used. First, the cellulose acetate was introduced into a dispersing tank and dispersed for 30 minutes using a dissolver-type eccentric stirring shaft stirring at a circumferential speed of 5 m/sec (shear stress 5×10⁴ kgf/m/sec² [4.9×10⁵ N/m/sec²]) and a stirring shaft with an anchor blade was mounted on the central axis thereof, stirring at a circumferential speed of 1 m/sec (shear stress 1×10⁴ kgf/m/sec² [9.8×10⁴ N/m/sec²]) The starting temperature of the dispersion was 25° C., whereas the final temperature was reached to 48° C. After completing the dispersion, high velocity stirring was stopped, and then, cellulose acetate flake was swelled by stirring further for 100 minutes at 0.5 m/sec of circumference velocity of the anchor blade. The tank was pressurized with a nitrogen gas to 0.12 MPa, until the swelling is completed. At this time, the oxygen concentration in the tank was less than 2% by volume, safe condition against explosion was maintained. In addition, it was confirmed that water content of dope was 0.5% by mass or less, and specifically 0.3% by mass.

The swollen solution was heated up to 50° C. from the tank through a jacketed pipe, and then heated up to 90° C. under a pressure of 2 MPa to achieve complete dissolution. Heating time was 15 minutes.

Subsequently, the solution was cooled to 36° C., and passed through a filter having a nominal hole diameter of 8 μm to obtain a dope. In this case, the primary pressure of filtration was 1.5 MPa, and the secondary pressure was 1.2 MPa. The filter, housing, and piping to be exposed to the high temperature were made of a highly anti-corrosive Hastelloy alloy (registered trademark) and jacketed for circulating a heating medium for heat insulation and heating.

The dope thus obtained prior to concentration was flashed in a tank at a normal pressure at 80° C., and the evaporated solvent was recovered and separated with a condenser. The solid concentration of the dope after the flash was 21.8% by mass. Meanwhile, the condensed solvent was returned to the recovering process so as to be reused as a solvent for the preparation process (the recovery is performed by the distillation process, dehydration process, and the like). The dope was defoamed in the flash tank by using a shaft equipped with an anchor blade on the central shaft to stir at a circumferential speed of 0.5 m/sec. The temperature of the dope in the tank was 25° C., and the average retention time in the tank was 50 min. The shear viscosity of the collected dope measured at 25° C. was 450(Pa·s) at a shear velocity of 10 (sec⁻¹).

Subsequently, the dope was defoamed by irradiating a weak ultrasonic wave thereto. Then, in a pressurized state to 1.5 MPa, the dope was first passed through a sintered woven metal filter having a nominal pore diameter of 10 μm and then through a sintered woven metal filter having a nominal pore diameter of 10 μm in the same manner. Each of the primary pressure was 1.5 MPa and 1.2 MPa, and the secondary pressure was 1.0 MPa and 0.8 MPa. The dope was stored in a 2000 L stainless steel stock tank while the temperature of the dope after the filtration was adjusted to 36° C. Dope 1 was obtained in the stock tank by using a shaft equipped with an anchor blade on the central shaft to stirr always at a circumferential speed of 0.5 msec. Meanwhile, when the dope was prepared from a dope before concentration, no problems were occurred, such as corrosion in the dope contact part.

Subsequently, dope 1 in the stock tank was transferred with a gear pump for increasing a primary pressure under feedback control by an inverter motor such that the primary pressure of the high precision gear pump becomes 0.8 MPa. The high precision gear pump has a performance of volumetric efficiency of 99.2% and discharging quantity variation of 0.5% or less. In addition, discharge pressure was 1.5 MPa.

(2) Preparation of Dope 2 for Support Layer

Dope 2 for the support layer was prepared by mixing matting agent (silicon dioxide (particle diameter of 20 nm)), peeling promoter (ethyl citrate ester (mixture of monoethyl citrate ester, diethyl ester and triethyl ester)) and dope 1 for the intermediate layer in a stationary mixer. The amount added was determined such that the concentration of the total solids is 20.5% by mass, the concentration of the matting agent is 0.05% by mass and the concentration of the peeling promoter is 0.03% by mass.

(3) Preparation of Dope 3 for Air Layer

Dope 3 for the air layer was prepared by mixing matting agent (silicon dioxide (particle diameter of 20 nm)) with dope 1 for the intermediate layer in a stationary mixer. The amount added was determined such that the concentration of the total solids is 20.5% by mass and the concentration of the matting agent is 0.1% by mass.

(4) Film Fabrication by Co-Casting

The casting die was equipped with a feed block having a width of 2.1 m and which is adjusted for co-casting, and used a device for allowing films to be stacked to form a structure of three layers on both sides thereof in addition to the main stream. In the following explanation, a layer to be formed from the main stream refers to an intermediate layer, a layer on the side of a support surface refers to a support surface, and the opposite surface refers to an air surface. Meanwhile, the solution sending flow channels of the dope use three flow channels for an intermediate layer, a support surface, and an air surface.

Dope for the intermediate layer, dope 2 for the support layer and dope 3 for the air layer were co-cast on a drum cooled to 0° C. from a casting nozzle. At this time, the flow of each dope was adjusted such that the ratio of thickness is air layer/middle layer/support layer=4/73/3. The cast dope film was dried with dry wind at 30° C. on the drum, and peeled from the drum under the state where the residual solvent is 150%. During peeling, 17% of stretching was performed in the transferring direction (the longitudinal direction). Then, while gripping both ends of the width direction (the direction perpendicular to the cast direction) of the film by a pin tenter (pin tenter as described in FIG. 3 of Japanese Patent Application Laid-Open No. H4-1009), 20% of stretching treatment was performed in the width direction. In addition, film 1 was prepared through further drying by transferring the film between the rolls of heat treatment unit. The amount of residual solvent of cellulose acylate film manufactured was 0.2%, and the thickness was 80 μm.

(Preparation of Film 2)

Film 2 with the thickness of 80 μm was prepared in the same manner as in Preparation of film 1, except that the stretching magnification in the width direction when gripping the pin tenter was adjusted to 30%.

(Preparation of Film 3)

A non-oriented film having a thickness of 104 μm was prepared in the same manner as in Preparation of film 1, except that the stretching magnification in the width direction when gripping the pin tenter was adjusted to 0%. The non-oriented film was gripped by the tenter clip in the width direction, heated to 175° C., and then stretched 30% in the width direction to obtain a film 3 with the thickness of 80 μm.

(Preparation of Film 4)

Film 4 having a thickness of 80 μm was prepared in the same manner as in Preparation of film 1, except that the stretching magnification in the transferring direction (in the longitudinal direction) during peeling was adjusted to 6%.

(Preparation of Film 5)

Film 5 was prepared in the same manner as in Preparation of film 2, except that the thickness after film-forming was adjusted to 60 μm.

(Preparation of Film 6)

Film 6 having a thickness of 60 μm was prepared in the same manner as in Preparation of film 5, except that the stretching magnification in the transferring direction (the longitudinal direction) during peeling was adjusted to 6%.

(Preparation of Film 7)

Film 7 having a thickness of 60 μm was prepared in the same manner as in Preparation of film 5, except that the content of triphenyl phosphate and the content of biphenyl diphenyl phosphate in the film after film-forming were reduced to the half thereof, respectively.

(Preparation of Film 8)

Film 8 having a thickness of 60 μm was prepared in the same manner as in Preparation of film 7, except that the stretching magnification in the transferring direction (the longitudinal direction) during peeling was adjusted to 6%.

(Preparation of Film 9)

Film 9 having a thickness of 80 μm was prepared in the same manner as in Preparation of film 2, except that the degree of acetyl substitution of the cellulose acetate was adjusted to 2.6.

(Preparation of Film 10)

Film 10 with the thickness of 80 μm was prepared in the same manner as in Preparation of film 1, except that the stretching magnification in the width direction when gripping the pin tenter was adjusted to 10%.

(Preparation of Film 11)

Dopes for inner layer and for outer layer were prepared respectively in the following composition.

| Composition of a dope for an inner Layer: | | |
|---|---|---|
| Cellulose acetate (degree of acetyl substitution | 100 | parts by mass |
| of 2.86, number average molecular weight of | | |
| 88000) | | |
| Triphenyl phosphate | 6.8 | parts by mass |
| Biphenyl diphenyl phosphate | 4.9 | parts by mass |
| Bluing dye of the following structure | 0.000078 | parts by mass |
| Dichloromethane | 439.1 | parts by mass |
| Methanol | 65.6 | parts by mass |
| Composition of a dope for an outer layer: | | |
| Cellulose acetate (degree of acetyl substitution | 100 | parts by mass |
| of 2.86, number average molecular weight of | | |
| 88000) | | |
| Triphenyl phosphate | 6.8 | parts by mass |
| Biphenyl diphenyl phosphate | 4.9 | parts by mass |
| Bluing dye of the following structure | 0.000078 | parts by mass |
| Silica particle with 16 nm of average particle | 0.14 | parts by mass |
| diameter (“aerosol R972”, manufactured by | | |
| Japan AEROSIL Co., Ltd.) | | |
| Dichloromethane | 424.5 | parts by mass |
| Methanol | 63.4 | parts by mass |

Bluing Dye

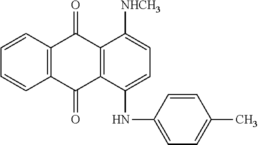 [SMILES: CNc1ccc(Nc2ccc(C)cc2)c2c1C(=O)c1ccccc1C2=O]

The dopes for the outer layer and inner layer having the above-described composition were uniformly and simultaneously layered product and co-cast on the stainless band support so as to be a structure of three layers of an outer layer on the support surface side, inner layer, and outer layer on the air interfacial side. Peeling was performed on the stainless band support by evaporating the solvent with the stainless band support until the amount of residual solvent reaches 40% by mass. After peeling, both ends were gripped, and then stretching was performed at 45%/minute of velocity in the width direction such that the stretching magnification becomes 1.15 times (15%).

When stretching is started, the amount of residual solvent was 30% by mass. While transferring after stretching, drying was performed in the drying zone at 115° C. for 35 minutes. After drying, slitting was performed in a width of 1980 mm to obtain a cellulose acylate film having a film thickness of 80 μm, and a film thickness ratio of the support surface side outer layer:inner layer:air interfacial side outer layer=3:94:3. This film was used as cellulose acylate film 11.

(Preparation of Film 12)

Film 12 having a thickness of 80 μm was prepared in the same manner as in Preparation of film 11, except that the stretching magnification in the width direction when gripping the tenter was adjusted to 30%.

(Preparation of Film 13)

The following composition was introduced into a mixing tank, and each component was dissolved by heating while stirring to prepare a cellulose acetate solution.

Composition of the composition

| | | |
|---|---|---|
| Cellulose acetate (degree of substitution of 2.86) | 100 | parts by mass |
| Polyester diol *2 | 10 | parts by mass |
| Solvent (the composition is described below) | 462 | parts by mass |

*2: A polyester diol composed of adipic acid and ethylene glycol, and having a hydroxyl number of 113.

Composition of the solvents was as follows.

Composition of the solvent

| | | |
|---|---|---|
| Methylenechloride(the primary solvent) | 100 | parts by mass |
| Methanol(the secondary solvent) | 19 | parts by mass |
| 1-butanol | 1 | part by mass |

The following composition was introduced into a mixing tank, and each component was dissolved by stirring to prepare a matting agent dispersion liquid. 1.3 parts by mass of the matting agent dispersion liquid was added to the cellulose acetate solution to prepare a dope.

Composition of the matting agent dispersion liquid

| | | |
|---|---|---|
| Silica particle dispersion fluid(average particle diameter | 10.0% | by mass |
| of 16 nm) (“AEROSIL R972”, manufactured by Japan | | |
| AEROSIL Co., Ltd.) | | |
| Methylene chloride | 72.8% | by mass |
| Methanol | 3.9% | by mass |
| Butanol | 0.5% | by mass |
| Cellulose acylate solution *1 | 10.3% | by mass |

*1: The cellulose acylate solution was prepared in the same manner, except that the solution is composed of adipic acid and ethylene glycol, and that 20 parts by mass of polyesterdiol having a hydroxyl number of 156 was added based on 100 parts by mass of the cellulose acetate (degree of substitution of 2.86).

The prepared dope was cast on the drum cooled to −5° C. from the casting nozzle. Peeling was performed in the state of the solvent content of approximately 70% by mass. Then, both ends of the film were fixed in the width direction (the direction perpendicular to the cast direction) by a pin tenter (pin tenter as described in FIG. 3 of Japanese Patent Laid-Open No. H4-1009), and drying was performed while maintaining the interval in which stretching magnification in the width direction (the direction vertical to the transferring direction) is 20% in the state of the solvent content of 5% by mass. Then, drying was further performed by transferring between the rolls of a heat treatment unit to prepare a cellulose acylate film having a width of 1.95 m and a thickness of about 60 μm. This film was used as film 13.

(Preparation of Film 14)

Film 14 having a thickness of 60 μm was prepared in the same manner as in Preparation of film 13, except that the stretching magnification in the width direction when gripping the pin tenter was adjusted to 30%.

(Preparation of Film 15)

The following composition was introduced into a mixing tank, and each component was dissolved by heating while stirring to prepare a cellulose acylate solution.

Composition of the cellulose acylate solution

| | | |
|---|---|---|
| Cellulose acylate(degree of acetyl substitution of 2.86, | 100 | parts by mass |
| viscosity average degree of polymerization of 310) | | |
| Polycondensed ester | 12 | parts by mass |
| Methylene chloride | 384 | parts by mass |
| Methanol | 69 | parts by mass |
| Butanol | 9 | parts by mass |

Meanwhile, the polycondensed ester is a polycondensed ester of mixed dicarboxylic acid (mixed dicarboxylic acid in which the mixing molar ratio of terephthalic acid and adipic acid is 50/50) and mixed diol (the mixing molar ratio of ethyleneglycol and 1,2-propanediol is 50/50), and a polycondensed ester-based plasticizer having a molecular weight of 1000, in which both ends are capped with acetyl ester residues.

(Preparation of Matting Agent Dispersion Liquid)

The following composition was introduced into a disperser, and each component was dissolved by stirring to prepare a matting agent dispersion liquid B.

Composition of matting agent dispersion liquid B

| | | |
|---|---|---|
| Silica particle dispersion liquid (average particle | 10.0 | parts by mass |
| diameter of 16 nm) “AEROSIL R972”, manufactured | | |
| by Japan AEROSIL Co., Ltd. | | |
| Methylene chloride | 72.8 | parts by mass |
| Methanol | 3.9 | parts by mass |
| Butanol | 0.5 | parts by mass |
| Cellulose acylate solution | 10.3 | parts by mass |

(Preparation of UV Absorbent Solution)

The following composition was introduced into a separate mixing tank, and each component was dissolved by heating while stirring to prepare an UV absorbent solution.

Composition of the UV Absorbent solution

| | | |
|---|---|---|
| UV absorbent (the following UV-1) | 4.0 | parts by mass |
| UV absorbent (the following UV-2) | 8.0 | parts by mass |
| UV absorbent (the following UV-3) | 8.0 | parts by mass |
| Methylene chloride | 55.7 | parts by mass |
| Methanol | 10 | parts by mass |
| Butanol | 1.3 | parts by mass |
| Cellulose acylate solution | 12.9 | parts by mass |

(UV-1) 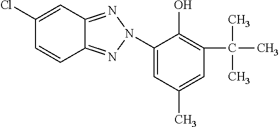 [SMILES: Cc1cc(-n2nc3ccc(Cl)cc3n2)c(O)c(C(C)(C)C)c1]
(UV-2) 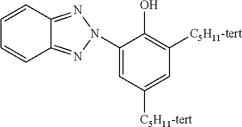
(UV-3)

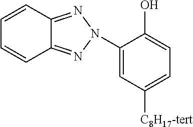

(Formation of Film)

To the mixture of 94.6 parts by mass of cellulose acylate solution and 1.3 parts by mass of matting agent dispersion liquid was added an UV absorbent solution, such that each of UV absorbent (UV-2) and UV absorbent (UV-3) is 0.4 parts by mass, UV absorbent (UV-1) is 0.2 parts by mass, and polycondensed ester is 12 parts by mass based on 100 parts by mass of the cellulose acylate, and then each component was dissolved by sufficiently stirring while heating to prepare a dope. The obtained dope was heated to 30° C. and cast on a mirror surface stainless support, which is a drum having a diameter of 3 m, through a casting basis. The surface temperature of support was set to −5° C., and the coating width was set to 1470 mm. The spatial temperature of entire casting part was set to 15° C. In addition, after peeling the cellulose acylate film which was rotating by casting from the drum immediately before 50 cm from the ending part of casting part, 15% of stretching treatment was performed in the width direction while transferring with clipping both ends with the pin tenter. The amount of residual solvent of the cellulose acylate web immediately after peeling was 70%, and film temperature of the cellulose acylate web was 5° C.

Cellulose acylate web fixed by the pin tenter was transferred to the drying zone. At the beginning of drying, dry wind was blown at 45° C. Subsequently, drying was performed at 110° C. for 5 minutes and then at 140° C. for 10 minutes, both edges were trimmed (approximately 5% of the total width) immediately before winding, and were subjected to a thickening process (knurling) to have a width of 10 mm and a height of 50 μm, and then were wound in a roll shape of 3000 m. The width of the cellulose acylate film obtained was 1.45 m. This film was used as cellulose acylate film 15.

(Preparation of Film 16)

Film 16 having a thickness of 60 μm was prepared in the same manner as in Preparation of film 15, except that the stretching magnification in the width direction when gripping the pin tenter was adjusted to 30%.

(Preparation of Film 17)

1] Material of Polymer Solution
Cellulose acylate:

Powder of a cellulose acetate having degree of substitution of 2.86 was used. The viscosity average degree of polymerization of cellulose acylate C1 was 300, the degree of acetyl substitution at 6-position was 0.89, acetone extract content was 7% by mass, the ratio of mass average molecular weight to number average molecular weight was 2.3, the water content was 0.2% by mass, the viscosity in 6% by mass of dichloromethane solution was 305 mPa·s, the amount of residual acetic acid was 0.1% by mass or less, the Ca content was 65 ppm, the Mg content was 26 ppm, the iron content was 0.8 ppm, the sulfate ion content was 18 ppm, the yellow index was 1.9, and the free acetic acid content was 47 ppm. The average particle size of powder was 1.5 mm, and the standard deviation was 0.5 mm.
Solvent: dichloromethane/methanol/butanol=81/18/1(mass ratio)
Additive A: an ester, which is a condensate of ethanediol/1,2-propanediol/adipic acid (molar ratio of 7/3/10), and is capped with acetic acid at both ends; number average molecular weight is 1000, hydroxyl group is 0

(Average number of carbons in polyhydric alcohol: 2.3, average number of carbons in polybasic acid: 6)
Additive N: a compound having the following structure

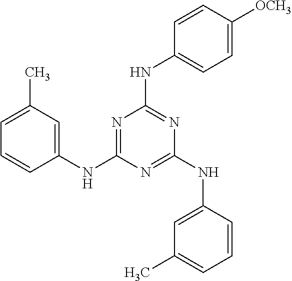 [SMILES: COc1ccc(Nc2nc(Nc3cccc(C)c3)nc(Nc3cccc(C)c3)n2)cc1]

Additive M: a particulate of silicon dioxide (particle size 20 nm, Moh's hardness of approximately 7) (0.02 parts by mass)

2] Preparation of Polymer Solution

The solvent and the additives were introduced into a 400 L stainless steel dissolver tank equipped with a stirring blade, in which a coolant is circulated on the circumference, and the cellulose acylate was slowly added thereto while the mixture in the tank was dispersed by stirring. After completion of the introduction, the mixture was stirred at room temperature for 2 hours, swollen for 3 hours, and again stirred to obtain a cellulose acylate solution.

(Amount of each component added)

| | | |
|---|---|---|
| Cellulose acylate | 20 | parts by mass |
| Solvent | 100 | parts by mass |
| Additive A | 9 | parts by mass |
| Additive N | 0.16 | parts by mass |
| Additive M | 0.02 | parts by mass |

For the stirring, a dissolver-type eccentric stirring shaft stirring at a circumferential speed of 15 msec (shear stress 5×10⁴ kgf/m/sec² [4.9×10⁵ N/m/sec²]) and a stirring shaft with an anchor blade was mounted on the central axis thereof, stirring at a circumferential speed of 1 msec (shear stress 1×10⁴ kgf/m/sec² [9.8²×10⁴ N/m/sec]), were used. The swelling was carried out by stopping the high-speed stirring shaft and setting the circumferential speed of the stirring shaft having the anchor blade to 0.5 m/sec. The swollen solution from the tank was then heated to 50° C. through a jacketed pipe and then heated up to 90° C. under a pressure of 2 MPa to achieve complete dissolution. The heating time was 15 minutes. In this case, the filter, housing, and piping to be exposed to the high temperature were made of a highly anti-corrosive Hastelloy alloy (registered trademark) and jacketed for circulating a heating medium for heat insulation and heating.

Subsequently, the solution was then cooled to 36° C. to obtain a cellulose acylate solution.

3] Filtration

The cellulose acylate solution obtained is filtered by a filter paper (#63, manufactured by Toyo Roshi Co., Ltd.) having an absolute filtration accuracy of 10 μm, and further filtered by a metal sintered filter (FH025, manufactured by Pall Corp.) having an absolute filtration accuracy of 2.5 μm to obtain a polymer solution.

4] Formation of Film

The polymer solution was heated to 30° C., and was cast on a mirror surface stainless support, which is a drum having a diameter of 3 m through the casting die. The surface temperature of support was set to −7° C., the casting speed was set to 50 m/minute, and the coating width was set to 200 cm. The spatial temperature of the entire casting part was set to 15° C. In addition, after peeling cellulose acylate film which was rotating by casting from the drum immediately before 50 cm from the ending part of casting part, both ends were clipped with the pin tenter. Meanwhile, the amount of residual solvent of the web immediately after peeled was 280% by mass as calculated based on the following equation.

Amount of residual solvent(% by mass)={(M−N)/N}×100

[Wherein, M represents mass of cellulose acylate film immediately before inserted into the stretching zone, and N represents mass of cellulose after dried for 3 hours at 110° C.]

Subsequently, the cellulose acylate film fixed by the pin tenter was stretched by 30% in the width direction and dried for 5 minutes at 100° C. After released from the pin tenter, both edges were cut by NT type cutter fixed to the left end and right end of the film, and were dried while being roll-transferred for 15 minutes at 70° C. to obtain film 17. The width and the thickness of film 17 were 2.0 m and 60 μm, respectively.

(Preparation of Film 18)

A main dope solution was prepared in the following composition. Methylene chloride and ethanol were added to a pressurized dissolving tank. Cellulose acetate was introduced to the pressurizing dissolution tank to which a solvent was added, while stirring. The mixture was completely dissolved while heating and stirring, and then, a plasticizer and an UV absorbent were added and dissolved. The mixture was filtered using AZUMI filtering paper No. 244 manufactured by AZUMI FILTER PAPER CO., LTD, to prepare a main dope solution.

<Composition of the main dope solution>

| | | |
|---|---|---|
| Methylene chloride | 440 | parts by mass |
| Ethanol | 40 | parts by mass |
| Cellulose acetate (degree of acetyl substitution of 2.9) | 100 | parts by mass |
| Triphenyl phosphate (plasticizer) | 9.5 | parts by mass |
| Ethylpthalylethyl glycolate (plasticizer) | 2.2 | parts by mass |
| TINUVIN 326(UV absorbent; manufactured by | 0.4 | parts by mass |
| Specialty Chemicals Co., Ltd.) | | |
| TINUVIN 109(UV absorbent; manufactured by | 0.7 | parts by mass |
| Specialty Chemicals Co., Ltd.) | | |
| TINUVIN 171(UV absorbent; manufactured by | 0.6 | parts by mass |
| Specialty Chemicals Co., Ltd.) | | |

The following components were mixed with stirring in a dissolver for 50 minutes, and then dispersed using Manton-Gaulin to prepare a particulate dispersion liquid having the following composition.

<Composition of particulate dispersion liquid>

| | | |
|---|---|---|
| Particulate (AEROSIL R972V (manufactured by Japan | 11 | parts by mass |
| AEROSIL Co., Ltd.)) | | |
| Ethanol | 89 | parts by mass |

Subsequently, the cellulose acetate (degree of acetyl substitution of 2.9) was added to a dissolving tank to which methylene chloride was added, and the mixture was completely dissolved by heating, and filtered using AZUMI filtering paper NO. 244 manufactured by AZUMI FILTER PAPER CO., LTD. The particulate dispersion liquid as prepared above was added slowly thereto while sufficiently stirring the solution after filtering. In addition, the mixture was dispersed using an attritor such that the particle diameter of the secondary particle has a desired size. This was filtered using FlNEMET NF manufactured by Nippon Seisen Co., Ltd. to prepare a particulate added solution.

| | | |
|---|---|---|
| Methylene chloride | 99 | parts by mass |
| Cellulose triacetate (degree of acetyl substitution of 2.9) | 4 | parts by mass |
| Particulate dispersion liquid | 11 | parts by mass |

100 parts by mass of the main dope solution and 2 parts by mass of the particulate added solution were added and mixed sufficiently in In-line Mixer (Toray Stationary In-tube Mixing Hi-Mixer, SWJ), and followed by casting uniformly on the stainless band support having a width of 2 m using belt casting apparatus. The solvent was evaporated on the stainless band support, and then peeled from the stainless band support. While gripping both ends of the film after peeling with the tenter clip, stretching was performed such that the stretching magnification in the width direction (TD) is 1.25 times (25%). After stretching, the width was maintained for several seconds to alleviate the tension in the width direction, and then, the width maintenance was released. Further, drying was performed by transferring for 30 minutes in the third drying zone set to 125° C. and then a film having a knurling with 1 cm wide and 8 μm high at the ending part was fabricated. This film was used as cellulose acylate film 18. The width and the thickness of film 18 were 2.0 m, 60 μm, respectively.

(Preparation of Film 19)

Film 19 having a thickness of 80 μm was prepared in the same manner as in Preparation of film 1, except that the stretching magnification in the width direction when gripping the pin tenter was adjusted to 0%.

(Preparation of Film 20)

A non-oriented film having a thickness of 135 μm was prepared in the same manner as in Preparation of film 1, except that the stretching magnification in the width direction when gripping the pin tenter was adjusted to 0%. The non-oriented film was gripped by the tenter clip in the width direction, heated to 185° C., and then stretched in the width direction to 70% to obtain a film 20 with the thickness of 80 μm.

(Preparation of Film 21)

A film 21 having a thickness of 80 μm was prepared in the same manner as in Preparation of film 11, except that the stretching magnification in the width direction when gripping the tenter was adjusted to 0%.

(Preparation of Film 22)

A non-oriented film having a thickness of 138 μm was prepared in the same manner as in Preparation of film 11, except that the stretching magnification in the width direction when gripping the pin tenter was adjusted to 0%. The non-oriented film was gripped by the tenter clip in the width direction, heated to 185° C., and then stretched in the width direction to 73% to obtain a film 22 with the thickness of 80 μm.

(Preparation of Film 23)

A film 23 having a thickness of 80 μm was prepared in the same manner as in Preparation of film 11, except that the stretching magnification in the width direction when gripping the tenter was adjusted to 0%, and 4 parts by mass of Additive N based on 100 parts by mass of the cellulose acetate, together with dopes for an inner layer and an outer layer.

(Preparation of Film 24)

A film 24 having a thickness of 60 μm was prepared in the same manner as in Preparation of film 13, except that the stretching magnification in the width direction when gripping the pin tenter was adjusted to 0%.

(Preparation of Film 25)

A film 25 having a thickness of 60 μm was prepared in the same manner as in Preparation of film 15, except that the stretching magnification in the width direction when gripping the pin tenter was adjusted to 0%.

(Preparation of Film 26)

A film 26 having a thickness of 80 μm was prepared in the same manner as in Preparation of film 17, except that the stretching magnification in the width direction when gripping the pin tenter was adjusted to 55%.

For the films 1 to 26 as prepared above, the performance of the films are shown in the following Table 1.

Further, the films 1 to 18 exemplified as examples were determined with respect to the variation in width direction of the humidity dimensional change rate in the TD direction. All films satisfied the condition of 10% or less.

TABLE 1

| | | Ratio of sound | | | | Ratio of moist heat | |
|---|---|---|---|---|---|---|---|
| | | velocity of the | | | | dimensional change | |
| | | width direction | Moist heat | | | rate of the | Moist heat |
| | | to that of the | dimensional change | | | longitudinal | dimensional change |
| | | longitudinal | in the width | | | direction to that of | rate in the width |
| | Film | direction | direction (%) | Re (nm) | Rth (nm) | the width direction | direction (%) |
| Example | 1 | 1.00 | 0.00 | 1 | 42 | 1.00 | 0.36 |
| | 2 | 1.09 | −0.12 | 2 | 44 | 1.54 | 0.33 |
| | 3 | 1.07 | −0.12 | 2 | 44 | 1.54 | 0.34 |
| | 4 | 1.09 | −0.12 | 1 | 43 | 1.59 | 0.32 |
| | 5 | 1.07 | −0.12 | 2 | 44 | 1.54 | 0.34 |
| | 6 | 1.09 | −0.12 | 1 | 43 | 1.59 | 0.32 |
| | 7 | 1.07 | −0.14 | 2 | 44 | 1.54 | 0.36 |
| | 8 | 1.09 | −0.14 | 2 | 45 | 1.59 | 0.35 |
| | 9 | 1.10 | 0.16 | 4 | 48 | 1.54 | 0.38 |
| | 10 | 0.92 | 0.15 | 4 | 46 | 0.85 | 0.38 |
| | 11 | 1.00 | 0.05 | 0 | 44 | 0.95 | 0.32 |
| | 12 | 1.10 | −0.10 | 2 | 45 | 1.54 | 0.30 |
| | 13 | 1.04 | 0.03 | 0 | 0 | 1.18 | 0.37 |
| | 14 | 1.10 | −0.10 | 0 | 2 | 1.17 | 0.35 |
| | 15 | 1.00 | 0.01 | 1 | 41 | 0.95 | 0.36 |
| | 16 | 1.10 | −0.05 | 2 | 43 | 1.54 | 0.30 |
| | 17 | 1.10 | −0.08 | 0 | 1 | 1.54 | 0.31 |
| | 18 | 0.95 | 0.15 | 1 | 40 | 1.71 | 0.37 |
| Comparative | 19 | 0.87 | 0.11 | 0 | 40 | 0.61 | 0.46 |
| Example | 20 | 1.30 | −0.32 | 4 | 48 | 1.80 | 0.29 |
| | 21 | 0.98 | 0.20 | 0 | 43 | 0.93 | 0.45 |
| | 22 | 1.35 | −0.34 | 2 | 5 | 2.00 | 0.25 |
| | 23 | 0.98 | 0.20 | 4 | 140 | 0.93 | 0.42 |
| | 24 | 0.95 | 0.10 | 0 | 0 | 0.84 | 0.45 |
| | 25 | 0.88 | 0.06 | 0 | 40 | 0.67 | 0.41 |
| | 26 | 1.25 | −0.25 | 0 | 0 | 1.60 | 0.35 |

For the sound velocity, the moist heat dimensional change, Re, Rth, the humidity dimensional change shown in Table 1, the measurement was conducted in the aforementioned method. Herein, Re and Rth are values at a wavelength of 550 nm.

[Preparation of Retardation Film]

Referring to “Site 2” and “Site 5” in Example 1 of Japanese Patent Application Laid-Open No. 2009-223001, a pattern retardation layer A is patterned such that a site (a first region) with the direction of the slow axis making an angle of 45° with the direction of the long side of the pattern and a site (a second region) with the direction of the slow axis making an angle of 135° with the direction of the long side are repeated with a period of 300 μm, and the retardation layer A is prepared on a glass substrate. This is transferred to the above-prepared support film shown in Table 2, thereby preparing Retardation Films 1 to 26 having the pattern retardation layer A.

For Retardation Films 1 to 26, the following evaluation is performed.

(Preparation of 3D Monitor)

A front polarizing plate HPL02065 (manufactured by HP Inc.) is peeled off, and a polarizing plate using each of the films in Examples and Comparative Examples as a protective film is affixed.

(Evaluation of Crosstalk)

The 3D monitor prepared above is lit for 48 hours continuously, then pixels for the right eye and pixels for the left eye are marked with a white pattern and a black pattern, respectively, a spectral radiance luminance meter (SR-3 manufactured by TOPCON Corp.) is placed at a position of eyes, and the luminance intensity is measured through each of circularly polarized light glasses for the right eye/left eye.

The luminance intensity of light transmitted through the circularly polarized light glasses for the right eye refers to Y RR and the luminance intensity of light transmitted through the circularly polarized light glasses for the left eye refers to Y RL.

When an image for the right eye enters the left eye and an image for the left eye enters the right eye, the 3D feeling is lost and thus, the degree of crosstalk is defined as CRO=(YRR−YRL)/(YRR+YRL) and evaluation is performed. The CRO immediately after the monitor is lit is defined as CRO 0 and the CRO after the monitor is lit for 48 hours is defined as CRO 48, evaluation is performed in accordance with the following criteria based on the value of 100*CRO_{—}48/CRO_{—}0.

AA: 95% or more

A: from 92.5% to less than 95% less

B: from 90% or more to less than 92.5%

C: less than 90%

As allowable evaluation values, ‘AA’ is most preferred, ‘A’ is next preferred, and ‘B’ is next less preferred. ‘C’ is not an allowable evaluation value requiring improvement.

Similarly, in the time-elapse measurement under a moist heat environment (moist heat endurance measurement), CRO after left standing for one day under 60° C. 90% RH environment was assigned as CRO_{—}60 and then display performances after moist heat endurance were evaluated based on the values of 100*CRO_{—}60/CRO_{—}0.

The result is shown in the following Table 2. From the result in Table 2, it is apparent that the retardation film prepared by using the cellulose ester film of the present invention is effective for alleviation of the crosstalk when the 3D display is continuously lit and the crosstalk caused by the lapse of time of moist heat. This is thought to be due to the suppression of the dimensional change of the cellulose ester film with lapse of time.

| | | | | Crosstalk after |
|---|---|---|---|---|
| | | Retardation | Crosstalk in | moist heat |
| | Film | Film | continuous lighting | edurance |
| Example | 1 | 1 | A | AA |
| | 2 | 2 | AA | AA |
| | 3 | 3 | AA | AA |
| | 4 | 4 | AA | AA |
| | 5 | 5 | AA | AA |
| | 6 | 6 | AA | AA |
| | 7 | 7 | AA | AA |
| | 8 | 8 | AA | AA |
| | 9 | 9 | A | A |
| | 10 | 10 | A | A |
| | 11 | 11 | AA | AA |
| | 12 | 12 | AA | AA |
| | 13 | 13 | A | AA |
| | 14 | 14 | AA | AA |
| | 15 | 15 | A | AA |
| | 16 | 16 | AA | AA |
| | 17 | 17 | AA | AA |
| | 18 | 18 | AA | AA |
| Comparative | 19 | 19 | C | C |
| Example | 20 | 20 | AA | C |
| | 21 | 21 | C | C |
| | 22 | 22 | AA | C |
| | 23 | 23 | C | C |
| | 24 | 24 | C | C |
| | 25 | 25 | C | C |
| | 26 | 26 | C | C |

Meanwhile, for all of films 1 to 26, variations in humidity dimensional change rate were 10% or less.

In the process of forming film 11, when half of dry air volume of the tenter part in the width direction is reduced by half, the humidity dimensional change rate of common part in the width direction was 0.32%, and the humidity dimensional change rate in the half air volume region was 0.39%. Therefore, the variation of humidity dimensional change rate in the width direction [(humidity dimensional change rate in the half air volume region−humidity dimensional change rate in common part)/(humidity dimensional change rate in common part)×100] became 22%. Continuous lighting crosstalk was evaluated by bonding to the monitor so as to include both ends. As a result, both regions are ‘AA’, but there is some difference in 3D feeling between the common region and the half air volume region, thereby deteriorating the film as compared with the uniform film in the front side of the monitor.

In addition, when using film 23, crosstalk was deteriorated rapidly when observing the panel from oblique direction as compared with observing in normal direction.

What is claimed is:

1. A cellulose ester film having: a ratio of a sound velocity in a width direction to a sound velocity in a longitudinal direction of from 0.9 to 1.1; a moist heat dimensional change rate in the width direction of from −0.2% to 0.2%, the moist heat dimensional change being one after the cellulose ester film is left standing at 60° C. and 90% RH for 24 hours; and a humidity dimensional change rate in the width direction of 0.38% or less.

2. The cellulose ester film of claim 1, wherein a variation of the humidity dimensional change rate in the width direction is 10% or less.

3. The cellulose ester film of claim 1, which has an in-plane retardation Re of from 0 nm to 5 nm and a thickness-direction retardation Rth of from 0 nm to 50 nm.

4. The cellulose ester film of claim 1, which has a width of from 1.8 m or more.

5. The cellulose ester film of claim 1, which comprises a cellulose acylate having a total degree of acyl substitution of from 2.7 to 3.0.

6. The cellulose ester film of claim 1, which comprises a cellulose ester and an additive in an amount of 10% by mass or more based on the cellulose ester.

7. A layered product comprising: a cellulose ester of claim 1; and an optically anisotropic layer.

8. The layered product of claim 7, wherein the optically anisotropic layer comprises a plurality of regions having refractive indices and arranged in a pattern in the longitudinal direction.

9. The layered product of claim 8, wherein the optically anisotropic layer comprises a first retardation region and a second retardation region that are arranged alternately in the width direction.

10. A polarizing plate comprising: a cellulose ester film of claim 1 as a protective film.

11. A liquid crystal display device comprising a polarizing plate of claim 10, wherein the protective film of the cellulose ester film is disposed closest to a viewer side.

12. A method for preparing an optical film comprising;
forming a web on a support with a solution in which a cellulose ester is dissolved in an organic solvent, and peeling the web from the support;
stretching the web from 10% to 40% in a width direction to form a film; and
stacking an optically anisotropic layer on the film, the optically anisotropic layer having a plurality of retardation regions disposed in the width direction.

13. The method of claim 12, wherein the optically anisotropic layer is formed by coating.
